(19) United States
(12) Patent Application Publication
(10) Pub. No.: US 2023/0179511 A1
(43) Pub. Date: Jun. 8, 2023

(54) TRANSMITTING APPARATUS, RECEIVING APPARATUS, TRANSMISSION METHOD, AND TRANSMITTING-RECEIVING SYSTEM

(71) Applicant: NIPPON TELEGRAPH AND TELEPHONE CORPORATION, Tokyo (JP)

(72) Inventors: Natsuki YASUHARA, Musashino-shi, Tokyo (JP); Takahiro KUBO, Musashino-shi, Tokyo (JP); Shinichi YOSHIHARA, Musashino-shi, Tokyo (JP); Go YAZAWA, Musashino-shi, Tokyo (JP)

(73) Assignee: NIPPON TELEGRAPH AND TELEPHONE CORPORATION, Tokyo (JP)

(21) Appl. No.: 17/925,824

(22) PCT Filed: May 25, 2020
(86) PCT No.: PCT/JP2020/020563

§ 371 Date: Nov. 16, 2022

(51) Int. Cl. H04L 45/00; H04L 1/22

(52) U.S. Cl. CPC H04L 45/22; H04L 1/22

(57) ABSTRACT

According to an embodiment, a transmission apparatus includes: a synchronization frame generation unit configured to generate a synchronization frame to be associated with a user frame; a synchronization frame identifier application unit configured to apply a synchronization frame identifier that enables recognition of a transmission order property of the synchronization frame to each synchronization frame generated by the synchronization frame generation unit and embed the synchronization frame identifier in the synchronization frame; a synchronization frame insertion unit configured to insert the synchronization frame with the synchronization frame identifier embedded therein by the synchronization frame identifier application unit into a point immediately after another user frame associated with another synchronization frame one before the user frame associated with the synchronization frame and immediately before the user frame associated with the synchronization frame; and a frame copying unit configured to copy the user frame and the synchronization frame inserted by the synchronization frame insertion unit.

### TECHNICAL FIELD

An aspect of the present invention relates to a transmission apparatus, a reception apparatus, a transmission method, and a transmission/reception system of a synchronization frame and a user frame.

### BACKGROUND ART

In a redundancy transmission scheme using a plurality of paths, the same information is transmitted through a plurality of paths. Even if an information frame of one path is lost due to communication disconnection or the like, recovery can be achieved using transmission information of another path.

NPL 1 discloses that a user frame is copied and transmitted and the same user frame arriving from a plurality of paths is selected. PTL 1 discloses that two copies are created from a transmission packet, a sequence number for identifying the same identification order is applied to each of the copied packets, and the packets are transmitted through different paths.

### CITATION LIST

### Patent Literature

PTL 1: JP 2005-102157 A

### Non Patent Literature

NPL 1: “Uninterrupted Redundancy Switching Techniques with Availability of Add-on to Existing NW,” Tsukuba Forum 2019, No. 32, October 2019. https://www.tsukuba-forum.jp/companylist_nttc3.html

### SUMMARY OF THE INVENTION

### Technical Problem

However, in a case where dedicated information such as a sequence number is applied to an information frame, lossless communication is realized by a dedicated apparatus determining a frame loss and complementing the information frame. Thus, installation of the dedicated apparatus for adding dedicated information to the information frame or for deleting the dedicated information from the information frame is needed at a communication site. For example, a single site where a dedicated apparatus is not installed cannot receive the information frame and cannot perform communication.

The present invention was made in view of the aforementioned circumstances and provides a technique that enables determination of a frame loss without application of information to a user frame.

### Means for Solving the Problem

According to an aspect of the present invention, there is provided a transmission apparatus including: a synchronization frame generation unit configured to generate a synchronization frame to be associated with one of user frames; a synchronization frame identifier application unit configured to apply, to each synchronization frame generated by the synchronization frame generation unit, a synchronization frame identifier that enables recognition of a transmission order property of the synchronization frame and embeds the synchronization frame identifier in the synchronization frame; a synchronization frame insertion unit configured to insert the synchronization frame with the synchronization frame identifier embedded therein by the synchronization frame identifier application unit into a point immediately after another user frame associated with another synchronization frame one before the user frame associated with the synchronization frame and immediately before the user frame associated with the synchronization frame; and a frame copying unit configured to copy the user frame and the synchronization frame inserted by the synchronization frame insertion unit and outputs the copied frames to a plurality of transmission FIFO queues corresponding to a plurality of output ports.

### EFFECTS OF THE INVENTION

According to the aspect of the present invention, it is possible to enable determination of a frame loss without application of information to a user frame. It is thus possible to realize lossless communication by establishing synchronization with a redundant path and securing redundancy.

### BRIEF DESCRIPTION OF DRAWINGS

FIG. 1 is an overview of a transmission/reception system according to a first embodiment of the present invention.

FIG. 2 is a block diagram illustrating a hardware configuration of an uninterrupted apparatus according to the first embodiment of the present invention.

FIG. 3 is a block diagram illustrating a software configuration of the uninterrupted apparatus according to the first embodiment of the present invention.

FIG. 4 is a diagram illustrating a configuration of a synchronization frame according to the first embodiment of the present invention.

FIG. 5 is a flowchart illustrating a processing procedure and processing content of transmission processing performed by the uninterrupted apparatus according to the first embodiment of the present invention.

FIG. 6 is a flowchart illustrating a processing procedure and processing content of reception processing of the uninterrupted apparatus according to the first embodiment of the present invention.

FIG. 7 is a diagram illustrating a frame sequence employed in the reception processing performed by the uninterrupted apparatus according to the first embodiment of the present invention.

FIG. 8 is a block diagram illustrating a software configuration of an uninterrupted apparatus according to a second embodiment of the present invention.

FIG. 9 is a diagram illustrating a configuration of a synchronization frame according to the second embodiment of the present invention.

FIG. 10 is a flowchart illustrating a processing procedure and processing content of transmission processing performed by the uninterrupted apparatus according to the second embodiment of the present invention.

FIG. 11 is a flowchart illustrating a processing procedure and processing content of reception processing performed by the uninterrupted apparatus according to the second embodiment of the present invention.

FIG. 12 is a diagram illustrating a frame sequence employed in reception processing performed by the uninterrupted apparatus according to the second embodiment of the present invention.

FIG. 13 is a diagram illustrating a frame sequence in the transmission processing performed by the uninterrupted apparatus according to the second embodiment of the present invention.

FIG. 14 is a block diagram illustrating a software configuration of an uninterrupted apparatus according to a third embodiment of the present invention.

FIG. 15 is a diagram illustrating a configuration of a synchronization frame according to the third embodiment of the present invention.

FIG. 16 is a flowchart illustrating a processing procedure and processing content of transmission processing performed by an uninterrupted apparatus according to the third embodiment of the present invention.

FIG. 17 is a flowchart illustrating a processing procedure and processing content of reception processing performed by the uninterrupted apparatus according to the third embodiment of the present invention.

FIG. 18 is a diagram illustrating a frame sequence employed in the reception processing performed by the uninterrupted apparatus according to the third embodiment of the present invention.

### DESCRIPTION OF EMBODIMENTS

Hereinafter, some embodiments of the present invention will be described with reference to the drawings.

### First Embodiment

### Configuration Example

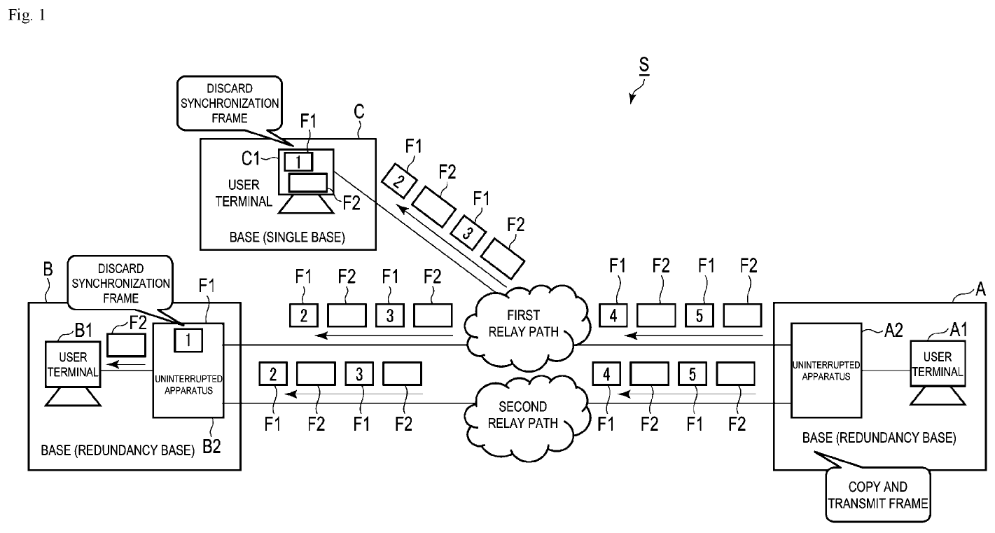

FIG. 1 is an overview of a transmission/reception system S.

The transmission/reception system S includes a user terminal A1 and an uninterrupted apparatus A2 at a base A, a user terminal B1 and an uninterrupted apparatus B2 at a base B, and a user terminal C1 at a base C. Note that the number of bases is not limited thereto.

The base A is a redundant base. The user terminal A1 is a terminal such as a personal computer (PC). The uninterrupted apparatus A2 is an apparatus that copies a synchronization frame F1 and a user frame F2 and transmits each frame via each of a first relay path and a second relay path. The uninterrupted apparatus A2 is an example of a transmission apparatus. The first relay path and the second relay path are examples of a plurality of relay paths.

The synchronization frame F1 is a short frame such as operation administration maintenance (OAM). The synchronization frame F1 is a general-purpose frame. The synchronization frame F1 is generated by the user terminal A1. The user frame F2 is a general-purpose frame from the user terminal A1.

The uninterrupted apparatus A2 is an apparatus that receives the synchronization frame F1 and the user frame F2 via each of the first relay path and the second relay path. The uninterrupted apparatus A2 discards the synchronization frame F1 and transmits the user frame F2 to the user terminal A1. The user terminal A1 processes the user frame F2. The uninterrupted apparatus A2 is also an example of a reception apparatus.

The base B is a redundant base. The user terminal B1 is an apparatus similar to the user terminal A1. The uninterrupted apparatus B2 is an apparatus similar to the uninterrupted apparatus A2. The uninterrupted apparatus B2 is both a transmission apparatus and a reception apparatus.

The base C is a single base. The user terminal C1 is an apparatus that receives the synchronization frame F1 and the user frame F2 from the first relay path. The user terminal C1 discards the synchronization frame F1 and processes the user frame F2.

Note that in a case where the uninterrupted apparatus A2 is referred to as a first uninterrupted apparatus, the uninterrupted apparatus B2 will also be referred to as a second uninterrupted apparatus. Alternatively, in a case where the uninterrupted apparatus B2 is referred to as a first uninterrupted apparatus, the uninterrupted apparatus A2 will also be referred to as a second uninterrupted apparatus.

Although the uninterrupted apparatus A2 will be described as an example below, the same description applies to the uninterrupted apparatus B2.

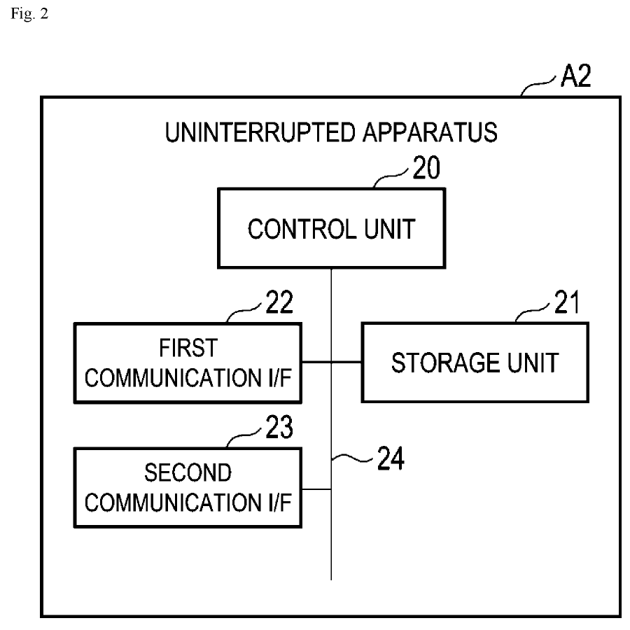

FIG. 2 is a block diagram illustrating a hardware configuration of the uninterrupted apparatus A2.

The uninterrupted apparatus A2 is constituted by a computer that processes each frame. The uninterrupted apparatus A2 includes a control unit 20, a storage unit 21, a first communication interface (I/F) 22, and a second communication I/F 23. The control unit 20, the storage unit 21, the first communication I/F 22, and the second communication I/F 23 are communicably connected to each other via a bus 24.

The control unit 20 controls the uninterrupted apparatus A2. The control unit 20 includes a hardware processor such as a central processing unit (CPU).

The storage unit 21 is a storage medium. For example, the storage unit 21 is configured as a storage medium by combining a non-volatile memory in which writing and reading can be performed at any time such as a hard disc drive (HDD) or a solid state drive (SDD), a non-volatile memory such as a read only memory (ROM), and a volatile memory such as a random access memory (RAM). Storage areas of the storage unit 21 include a program storage area and a data storage area. The program storage area stores application programs needed to perform various kinds of processing in addition to middleware such as an operating system (OS).

The first communication I/F 22 is an interface that enables communication with the user terminal A1. For example, the first communication I/F 22 enables wired communication with the user terminal A1 in accordance with a predetermined standard. The first communication I/F 22 receives the user frame F2 from the user terminal A1. Alternatively, the first communication I/F 22 transmits the user frame F2 received from the user terminal B2 to the user terminal A1.

The second communication I/F 23 is an interface that enables communication with other apparatuses via a plurality of relay paths in a network such as the Internet. For example, the second communication I/F 23 enables wireless communication with other apparatuses in accordance with a predetermined standard. The second communication I/F 23 receives the synchronization frame F1 and the user frame F2 via each of a plurality of relay paths. Alternatively, the second communication I/F 23 transmits the synchronization frame F1 and the user frame F2 through each of the plurality of relay paths.

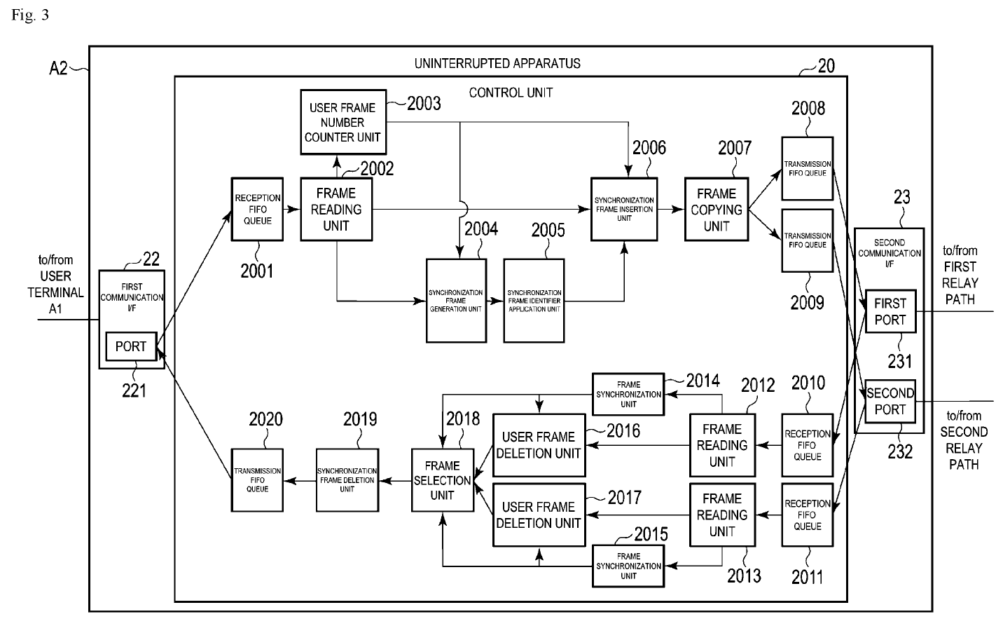

FIG. 3 is a block diagram illustrating a software configuration of the uninterrupted apparatus A2.

The control unit 20 executes a reception first-in-first-out (FIFO) queue 2001, a frame reading unit 2002, a user frame number counter unit 2003, a synchronization frame generation unit 2004, a synchronization frame identifier application unit 2005, a synchronization frame insertion unit 2006, a frame copying unit 2007, a transmission FIFO queue 2008, a transmission FIFO queue 2009, a reception FIFO queue 2010, a reception FIFO queue 2011, a frame reading unit 2012, a frame reading unit 2013, a frame synchronization unit 2014, a frame synchronization unit 2015, a user frame deletion unit 2016, a user frame deletion unit 2017, a frame selection unit 2018, a synchronization frame deletion unit 2019, and a transmission FIFO queue 2020 by activating an application program stored in the storage unit 21. The reception FIFO queue 2001, the frame reading unit 2002, the user frame number counter unit 2003, the synchronization frame generation unit 2004, the synchronization frame identifier application unit 2005, the synchronization frame insertion unit 2006, the frame copying unit 2007, the transmission FIFO queue 2008, and the transmission FIFO queue 2009 are related to transmission processing. The reception FIFO queue 2010, the reception FIFO queue 2011, the frame reading unit 2012, the frame reading unit 2013, the frame synchronization unit 2014, the frame synchronization unit 2015, the user frame deletion unit 2016, the user frame deletion unit 2017, the frame selection unit 2018, the synchronization frame deletion unit 2019, and the transmission FIFO queue 2020 are related to reception processing.

The reception FIFO queue 2001 inputs, in order, the user frame F2 received at a port 221 of the first communication I/F 22 from the user terminal A1 and outputs the user frame F2 in the input order.

The frame reading unit 2002 reads the user frame F2 input in order to the reception FIFO queue 2001 from the reception FIFO queue 2001 in the input order.

The user frame number counter unit 2003 counts the number of the user frames F2 read by the frame reading unit 2002.

The synchronization frame generation unit 2004 generates the synchronization frame F1.

The synchronization frame identifier application unit 2005 applies a synchronization frame identifier to each synchronization frame F1 generated by the synchronization frame generation unit 2004. The synchronization frame identifier application unit 2005 embeds the synchronization frame identifier in the synchronization frame F1. The synchronization frame identifier is an identifier that enables recognition of a transmission order property of the synchronization frame F1. The synchronization frame identifier is a value that is different for each synchronization frame F1 and increases in the transmission order of the synchronization frame F1, and is zero or a positive integer.

The synchronization frame insertion unit 2006 inserts the synchronization frame F1 with the synchronization frame identifier embedded therein by the synchronization frame identifier application unit 2005 between two successive user frames F2.

The frame copying unit 2007 copies the user frame F2 read by the frame reading unit 2002 and the synchronization frame F1 inserted by the synchronization frame insertion unit 2006. The frame copying unit 2007 outputs the copied synchronization frame F1 and the user frame F2 to the transmission FIFO queue 2008 and the transmission FIFO queue 2009 corresponding to a first port 231 and a second port 232 of the second communication I/F 23. The first port 231 and the second port 232 are an example of the plurality of output ports. The transmission FIFO queue 2008 and the transmission FIFO queue 2009 are an example of the plurality of transmission FIFO queues.

The transmission FIFO queue 2008 inputs any of the synchronization frames F1 and the user frames F2 from the frame copying unit 2007 in order and outputs the frames to the first port 231 in the input order. In this manner, a frame sequence constituted by the plurality of synchronization frames F1 and the plurality of user frames F2 is transmitted from the uninterrupted apparatus A2 to the uninterrupted apparatus B2 and the user terminal C1 via the first relay path.

The transmission FIFO queue 2009 inputs any of the synchronization frames F1 and the user frames F2 from the frame copying unit 2007 in order and outputs the frames to the second port 232 in the input order. In this manner, a frame sequence constituted by the plurality of synchronization frames F1 and the plurality of user frames F2 is transmitted from the uninterrupted apparatus A2 to the uninterrupted apparatus B2 via the second relay path.

The reception FIFO queue 2010 inputs any of the synchronization frames F1 and the user frames F2 received at the first port 231 of the second communication I/F 23 from the uninterrupted apparatus B2 via the first relay path in order and outputs the frames in the input order. The first port 231 is an example of the input port.

The reception FIFO queue 2011 inputs any of the synchronization frames F1 and the user frames F2 received at the second port 232 of the second communication I/F 23 from the uninterrupted apparatus B2 via the second relay path in order and outputs the frames in the input order. The second port 232 is an example of the input port.

The frame reading unit 2012 reads any of the synchronization frames F1 and the user frames F2 input to the reception FIFO queue 2010 in order from the reception FIFO queue 2010 in the input order.

The frame reading unit 2013 reads any of the synchronization frames F1 and the user frames F2 input to the reception FIFO queue 2011 in order from the reception FIFO queue 2011 in the input order.

[Note that the frame reading unit 2012 and the frame reading unit 2013 may be collectively referred to as a frame reading unit.

The frame synchronization unit 2014 determines an order property of each frame via the first relay path that has been read by the frame reading unit 2012, and generates order information. The order information is information related to how accurate the order properties of the synchronization frames F1 and the user frames F2 are.

The frame synchronization unit 2015 determines an order property of each frame via the second relay path that has been read by the frame reading unit 2013, and generates order information.

Note that the frame synchronization unit 2014 and the frame synchronization unit 2015 may be collectively referred to as a frame synchronization unit.

The user frame deletion unit 2016 deletes the user frames F2 via the first relay path that have been read by the frame reading unit 2012 as needed based on the order information from the frame synchronization unit 2014.

The user frame deletion unit 2017 deletes the user frames F2 via the second relay path that have been read by the frame reading unit 2013 as needed based on the order information from the frame synchronization unit 2015.

Note that the user frame deletion unit 2016 and the user frame deletion unit 2017 may be collectively referred to as a frame deletion unit.

The frame selection unit 2018 selects the synchronization frames F1 and the user frames F2 via the first relay path or the second relay path based on the order information from the frame synchronization unit 2014 and the order information from the frame synchronization unit 2015.

The synchronization frame deletion unit 2019 deletes the synchronization frames F1 out of the synchronization frames F1 and the user frames F2 selected by the frame selection unit 2018. The synchronization frame deletion unit 2019 outputs the user frames F2 out of the synchronization frame F1 and the user frame F2 selected by the frame selection unit 2018 to the transmission FIFO queue 2020.

The transmission FIFO queue 2020 inputs the user frames F2 from the synchronization frame deletion unit 2019 in order and outputs the user frames F2 to the port 221 in the input order. The port 221 is an example of the output port. In this manner, a frame sequence constituted by the plurality of user frames F2 is transmitted to the user terminal A1.

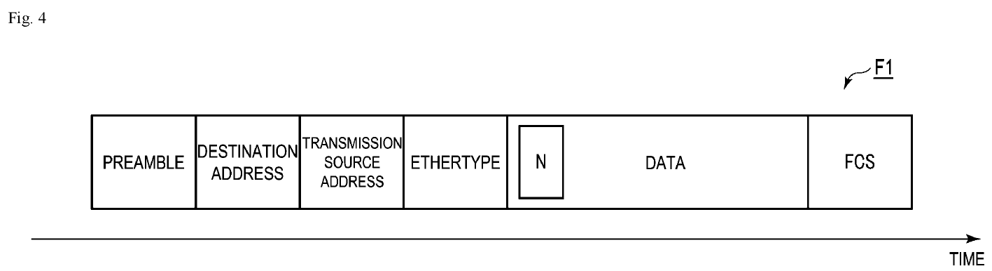

FIG. 4 is a diagram illustrating a configuration of a synchronization frame F1. For example, the synchronization frame F1 is a frame constituted by fields of a preamble, a destination address, a transmission source address, an Ethertype, data, and a frame check sequence (FCS). The synchronization frame identifier is embedded in the data field. “N” is a value of a synchronization frame identifier that is different for each synchronization frame F1.

### Operation Example

Operations executed by the uninterrupted apparatus A2 configured as described above will be described.

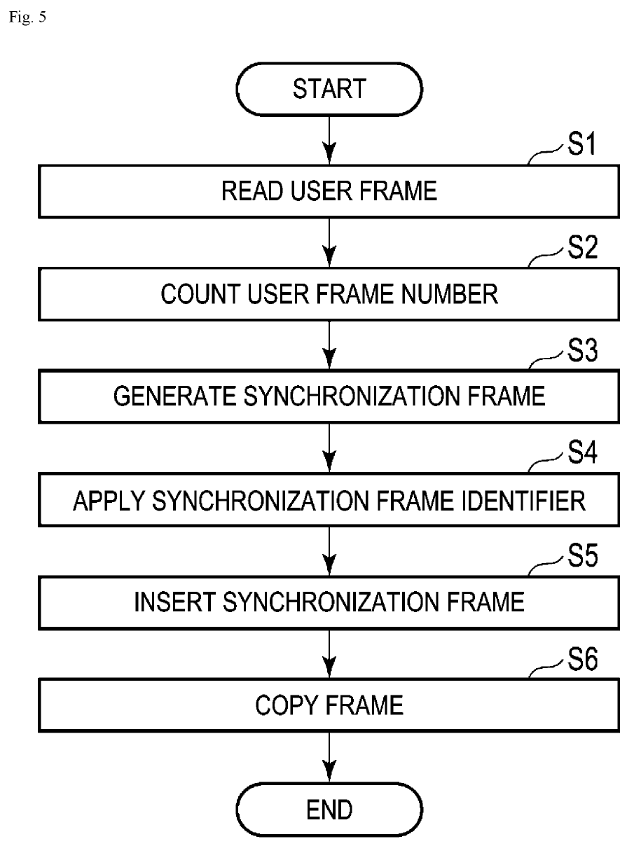

FIG. 5 is a flowchart illustrating a processing procedure and processing content of transmission processing of the uninterrupted apparatus A2. Here, transmission processing in which the uninterrupted apparatus A2 transmits the same frame sequence to the uninterrupted apparatus B2 via both the first relay path and the second relay path will be described as an example.

The frame reading unit 2002 reads user frames F2 input to the reception FIFO queue 2001 in order from the reception FIFO queue 2001 in the input order (Step S1). In Step S1, the frame reading unit 2002 reads the user frames F2 from the user terminal A1 in order, for example.

The user frame number counter unit 2003 counts the number of user frames F2 read by the frame reading unit 2002 (Step S2). In Step S2, the user frame number counter unit 2003 counts the number of user frames F2 every time the frame reading unit 2002 reads the user frames F2, for example.

The synchronization frame generation unit 2004 generates a synchronization frame F1 to be associated with each user frame F2 (Step S3). In Step S3, the synchronization frame generation unit 2004 generates one synchronization frame F1 for one user frame F2 counted by the user frame number counter unit 2003, for example.

The synchronization frame identifier application unit 2005 applies a synchronization frame identifier to each synchronization frame F1 generated by the synchronization frame generation unit 2004 and embeds the synchronization frame identifier in the synchronization frame F1 (Step S4). In Step S4, the synchronization frame identifier application unit 2005 applies a value N of the synchronization frame identifier to each synchronization frame F1 in order from zero every time the synchronization frame generation unit 2004 generates the synchronization frame F1, for example. The synchronization frame identifier application unit 2005 embeds one synchronization frame identifier in each synchronization frame F1.

The synchronization frame insertion unit 2006 inserts the synchronization frame F1 with the synchronization frame identifier embedded therein by the synchronization frame identifier application unit 2005 between two successive user frames F2 (Step S5). In Step S5, the synchronization frame insertion unit 2006 inserts the synchronization frame F1 into a point immediately after another user frame F2 associated with another synchronization frame F1 one before the user frame F2 associated with the synchronization frame F1 and immediately before the user frame F2 associated with the synchronization frame F1, for example. A case in which the value of the synchronization frame identifier is two will be described as an example. The synchronization frame insertion unit 2006 inserts the synchronization frame F1 with the synchronization frame identifier with a value two embedded therein into a point immediately after another user frame F2 associated with the synchronization frame F1 with the synchronization frame identifier with a value one embedded therein and immediately before the user frame F2 associated with the synchronization frame F1 with the synchronization frame identifier with the value two embedded therein. In other words, the synchronization frame insertion unit 2006 inserts the synchronization frame F1 between two successive user frames F2 such that the synchronization frames F1 and the user frames F2 are alternately arranged one by one. A synchronization group is constituted by one synchronization frame F1 and one user frame F2 immediately after the synchronization frame F1.

The frame copying unit 2007 copies the synchronization frame F1 and the user frame F2 (Step S6). In Step S6, the frame copying unit 2007 copies the user frame F2 read by the frame reading unit 2002 and the synchronization frame F1 inserted by the synchronization frame insertion unit 2006, for example. The frame copying unit 2007 copies a frame sequence constituted by a plurality of synchronization frames F1 and a plurality of user frames F2. The frame copying unit 2007 outputs the copied synchronization frames F1 and user frames F2 to a plurality of transmission FIFO queues corresponding to a plurality of output ports. The frame copying unit 2007 outputs the copied synchronization frame F1 and the user frame F2 to the transmission FIFO queue 2008 and the transmission FIFO queue 2009 corresponding to a first port 231 and a second port 232 of the second communication I/F 23. The frame copying unit 2007 outputs the same frame sequence constituted by the copied plurality of synchronization frames F1 and plurality of user frames F2 to the transmission FIFO queue 2008 and the transmission FIFO queue 2009. In this manner, the same frame sequence is transmitted from the uninterrupted apparatus A2 to the uninterrupted apparatus B2 via both the first relay path and the second relay path.

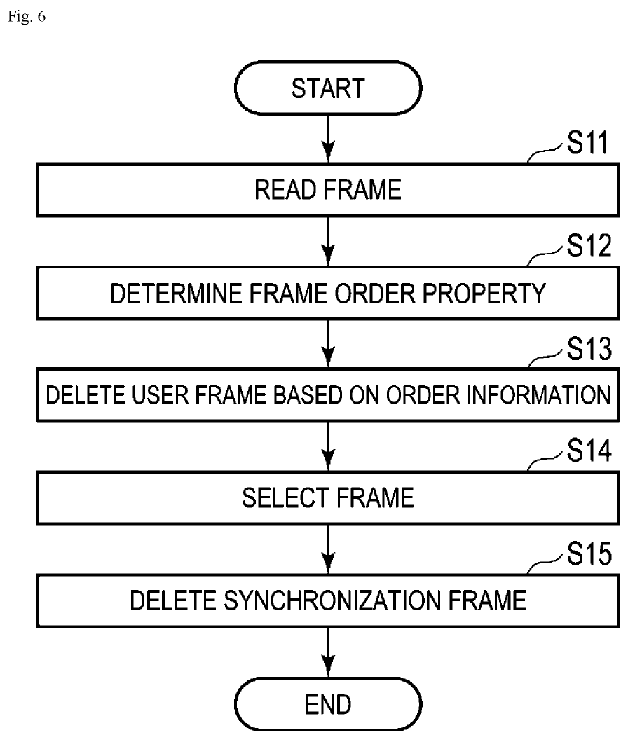

FIG. 6 is a flowchart illustrating a processing procedure and processing content of reception processing of the uninterrupted apparatus A2. Here, reception processing in which the uninterrupted apparatus A2 receives the same frame sequence from the uninterrupted apparatus B2 via both the first relay path and the second relay path will be described as an example.

The frame reading unit 2012 and the frame reading unit 2013 read the synchronization frames F1 with the synchronization frame identifiers embedded therein and the user frames F2 input from the plurality of relay paths to each of the plurality of reception FIFO queues in order (Step S11). In Step S11, the frame reading unit 2012 reads any of the synchronization frames F1 and the user frames F2 input in order from the first relay path to the reception FIFO queue 2010 from the reception FIFO queue 2010 in the input order, for example. The frame reading unit 2013 reads, from the reception FIFO queue 2011 in the input order, any of the synchronization frames F1 and the user frames F2 input from the second relay path to the reception FIFO queue 2011 in order.

The frame synchronization unit 2014 and the frame synchronization unit 2015 determines an order property of each frame via the plurality of relay paths (Step S12). In Step S 12, the frame synchronization unit 2014 recognizes the order property of the synchronization frames F1 based on the synchronization frame identifiers of the synchronization frames F1 via the first relay path, which have been read by the frame reading unit 2012, for example. The frame synchronization unit 2014 determines whether or not the order property of the synchronization frame F1 is accurate (an accurate order in accordance with the synchronization frame identifiers). The fact that the order is accurate corresponds to a fact that there is no frame loss. The frame synchronization unit 2014 counts the user frames F2 included between the synchronization frame F1 and the next synchronization frame F1 based on the synchronization frame identifiers. In a case where the number of user frames F2 included between the synchronization frame F1 and the next synchronization frame F1 is one, the frame synchronization unit 2014 determines that a synchronization group identified with the value N of the synchronization frame identifier of the synchronization frame F1 has been synchronized. The fact that the synchronization group is determined to have been synchronized corresponds to a fact that an order property of the synchronization frame F1 and the user frame F2 associated with the synchronization frame F1, which constitute the synchronization group identified with the value N of the synchronization frame identifier of the synchronization frame F1, is determined to be accurate. The frame synchronization unit 2014 generates order information indicating synchronization of the synchronization group identified with the value N of the synchronization frame identifier of the synchronization frame F1. On the other hand, in a case where the number of the user frames F2 included between the synchronization frame F1 and the next synchronization frame F1 is zero or greater than one, the frame synchronization unit 2014 determines that the synchronization group identified with the value N of the synchronization frame identifier of the synchronization frame F1 has not been synchronized. The fact that the synchronization group is determined to have not been synchronized corresponds to a fact that an order property of the synchronization frame F1 and the user frames F2 associated with the synchronization frame F1, which constitute the synchronization group identified with the value N of the synchronization frame identifier of the synchronization frame F1, is not accurate (non-accurate order). The fact that the order property is not accurate corresponds to a fact that there is a frame loss. The case in which the number of the user frames F2 included between the synchronization frame F1 and the next synchronization frame F1 is zero corresponds to a frame loss of the user frame F2. The case in which the number of the user frames F2 included between the synchronization frame F1 and the next synchronization frame F1 is greater than one corresponds to a frame loss of the synchronization frame F1 in which the synchronization frame identifier of a next value of the synchronization frame identifier embedded in the synchronization frame F1 is embedded. The frame synchronization unit 2014 generates order information indicating that the synchronization group identified with the value N of the synchronization frame identifier of the synchronization frame F1 has not been synchronized. In this manner, the frame synchronization unit 2014 generates order information indicating that each synchronization group identified with the value N of the synchronization frame identifier of the synchronization frame F1 has been synchronized or has not been synchronized. The order information can include information indicating whether or not the order property of the synchronization frame F1 is accurate. The order information can include the value N of the synchronization frame identifier.

The frame synchronization unit 2015 recognizes the order property of the synchronization frames F1 based on the synchronization frame identifiers of the synchronization frames F1 via the second relay path, which have been read by the frame reading unit 2013. The frame synchronization unit 2015 determines whether or not the order property of the synchronization frames F1 is correct. The frame synchronization unit 2015 counts the number of user frames F2 included between the synchronization frame F1 and the next synchronization frame F1 based on the synchronization frame identifiers. In a case where the number of user frames F2 included between the synchronization frame F1 and the next synchronization frame F1 is one, the frame synchronization unit 2015 determines that the synchronization group identified with the value N of the synchronization frame identifier of the synchronization frame F1 has been synchronized. The frame synchronization unit 2015 generates order information indicating that the synchronization group identified with the synchronization frame identifier N of the synchronization frame F1 has been synchronized. On the other hand, in a case where the number of the user frames F2 included between the synchronization frame F1 and the next synchronization frame F1 is zero or greater than one, the frame synchronization unit 2015 determines that the synchronization group identified with the value N of the synchronization frame identifier of the synchronization frame F1 has not been synchronized. The frame synchronization unit 2015 generates order information indicating that the synchronization group identified with the value N of the synchronization frame identifier of the synchronization frame F1 has not been synchronized. In this manner, the frame synchronization unit 2015 generates order information indicating that each synchronization group identified with the value N of the synchronization frame identifier of the synchronization frame F1 has been synchronized or has not been synchronized. The order information can include information indicating whether or not the order property of the synchronization frame F1 is accurate. The order information can include the value N of the synchronization frame identifier.

The user frame deletion unit 2016 and the user frame deletion unit 2017 delete the user frames F2 via the plurality of relay paths as needed based on the order information from the frame synchronization unit 2014 and the frame synchronization unit 2015 (Step S13). In Step S13, the user frame deletion unit 2016 deletes the user frames F2 included between the synchronization frame F1 included in the synchronization group which is indicated as having not been synchronized by the order information from the frame synchronization unit 2014 and the next synchronization frame F1 for the synchronization group. On the other hand, the user frame deletion unit 2016 does not delete the user frames F2 included between the synchronization frame F1 included in the synchronization group which is indicated as having been synchronized by the order information from the frame synchronization unit 2014 and the next synchronization frame F1 for the synchronization group. The user frame deletion unit 2017 deletes the user frames F2 included between the synchronization frame F1 included in the synchronization group indicated as having not been synchronized by the order information from the frame synchronization unit 2015 and the next synchronization frame F1 for the synchronization group. On the other hand, the user frame deletion unit 2017 does not delete the user frames F2 included between the synchronization frame F1 included in the synchronization group indicated as having been synchronized by the order information from the frame synchronization unit 2015 and the next synchronization frame F1 for the synchronization group.

The frame selection unit 2018 employs a synchronization group constituted by one synchronization frame F1 in a relay path through which the frames have arrived in the accurate order determined based on the synchronization frame identifiers and have arrived earliest out of the first relay path and the second relay path and one user frame F2 associated with the synchronization frame F1. (Step S14). In Step S14, the frame selection unit 2018 employs a synchronization group of an accurate order and in a relay path through which frames have arrived earliest out of the first relay path and the second relay path for each value N of the synchronization frame identifier based on the order information from the frame synchronization unit 2014 and the order information from the frame synchronization unit 2015, for example The employing of a synchronization group includes selecting of a synchronization group.

For example, it is assumed that order information from the frame synchronization unit 2014 indicates synchronization and includes information indicating that the order property of the synchronization frame F1 is accurate, in regard to the value N of a certain synchronization frame identifier. It is assumed that the order information from the frame synchronization unit 2015 indicates synchronization and includes information indicating that the order property of the synchronization frame F1 is accurate. The frame selection unit 2018 determines that the synchronization frame F1 and the user frame F2 constituting a synchronization group of the first relay path are in an accurate order, based on the order information from the frame synchronization unit 2014. Because the order information from the frame synchronization unit 2014 is generated based on the synchronization frame identifiers, it is possible to state that the frame selection unit 2018 determines that the order is accurate based on the synchronization frame identifiers. The frame selection unit 2018 determines that the synchronization frame F1 and the user frame F2 constituting a synchronization group of the second relay path are in an accurate order, based on the order information from the frame synchronization unit 2015. Because the order information from the frame synchronization unit 2015 is generated based on the synchronization frame identifiers, it is possible to state that the frame selection unit 2018 determines that the order is accurate based on the synchronization frame identifiers. The frame selection unit 2018 employs a synchronization group in a relay path through which the frames have arrived in the accurate order and earliest out of the first relay path and the second relay path. The synchronization group in the first relay path is constituted by one synchronization frame F1 read by the frame reading unit 2012 and one user frame F2 that has not been deleted by the user frame deletion unit 2016. The synchronization group in the second relay path is constituted by one synchronization frame F1 read by the frame reading unit 2013 and one user frame F2 that has not been deleted by the user frame deletion unit 2017. The frame selection unit 2018 deletes frames constituting the synchronization group in the relay path that is not employed out of the first relay path and the second relay path.

For example, it is assumed that order information from the frame synchronization unit 2014 indicates synchronization and includes information indicating that the order property of the synchronization frame F1 is accurate, in regard to the value N of a certain synchronization frame identifier. It is assumed that the order information from the frame synchronization unit 2015 indicates non-synchronization and includes information indicating that the order property of the synchronization frames F1 is accurate. The frame selection unit 2018 determines that the synchronization frame F1 and the user frame F2 constituting a synchronization group of the first relay path are in an accurate order, based on the order information from the frame synchronization unit 2014. The frame selection unit 2018 determines that the frames constituting the synchronization group in the second relay path are in an inaccurate order, based on the order information from the frame synchronization unit 2015. Because the order information from the frame synchronization unit 2015 is generated based on the synchronization frame identifier, it is possible to state that the frame selection unit 2018 determines that the order is not accurate based on the synchronization frame identifiers. In this example, the synchronization group in the first relay path is the synchronization group of the relay path through which the frames have arrived in the accurate order and earliest out of the first relay path and the second relay path. The frame selection unit 2018 employs the synchronization group in the first relay path. The frame selection unit 2018 does not employ the synchronization group in the second relay path. The frame selection unit 2018 deletes the frames constituting the synchronization group in the second relay path that is not employed.

For example, it is assumed that the order information from the frame synchronization unit 2014 indicates non-synchronization and includes information indicating that the order property of the synchronization frames F1 is accurate, in regard to the value N of a certain synchronization frame identifier. It is assumed that the order information from the frame synchronization unit 2015 indicates synchronization and includes information indicating that the order property of the synchronization frame F1 is accurate. The frame selection unit 2018 determines that the frames constituting the synchronization group in the first relay path are in an inaccurate order, based on the order information from the frame synchronization unit 2014. The frame selection unit 2018 determines that the synchronization frame F1 and the user frame F2 constituting a synchronization group of the second relay path are in an accurate order, based on the order information from the frame synchronization unit 2015. In this example, the synchronization group in the second relay path is a synchronization group in the relay path through which frames have arrived in the accurate order and earliest out of the first relay path and the second relay path. The frame selection unit 2018 employs the synchronization group in the second relay path. The frame selection unit 2018 does not employ the synchronization group in the first relay path. The frame selection unit 2018 deletes frames constituting the synchronization group in the first relay path that is not employed.

The synchronization frame deletion unit 2019 deletes the synchronization frame F1 out of the synchronization frame F1 and the user frame F2 included in the synchronization group employed by the frame selection unit 2018 (Step S15). In Step S15, the synchronization frame deletion unit 2019 deletes the synchronization frame F1 in each synchronization group employed by the frame selection unit 2018 in the accurate order identified with the synchronization frame identifiers. On the other hand, the synchronization frame deletion unit 2019 outputs the user frame F2 out of the synchronization frame F1 and the user frame F2 included in the synchronization group employed by the frame selection unit 2018 to the transmission FIFO queue 2020. In this manner, the synchronization frame deletion unit 2019 outputs the user frame F2 of each synchronization group selected by the frame selection unit 2018 to the transmission FIFO queue 2020. A frame sequence constituted by a plurality of user frames F2 is transmitted to the user terminal A1.

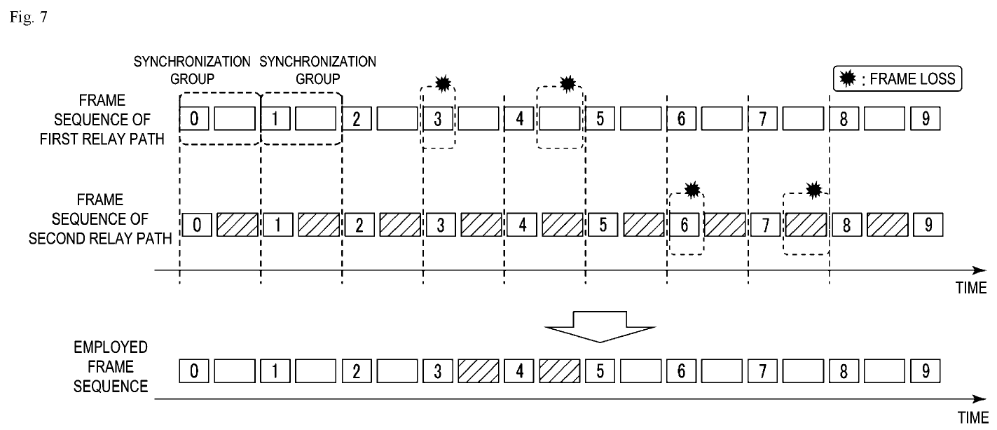

FIG. 7 is a diagram illustrating a frame sequence employed by the reception processing performed by the uninterrupted apparatus A2.

The frame sequence via the first relay path is assumed to arrive at the uninterrupted apparatus A2 earlier than the frame sequence via the second relay path.

The frame selection unit 2018 employs the synchronization group in the relay path through which frames have arrived in the accurate order and earliest out of the first relay path and the second relay path, in order from the value zero of the synchronization frame identifier.

For the value zero of the synchronization frame identifier, both the synchronization group in the first relay path and the synchronization group in the second relay path are synchronization groups in accurate orders. The synchronization group in the first relay path has arrived earlier than the synchronization group in the second relay path. Thus, the synchronization group in the first relay path is the synchronization group in the relay path through which the frames have arrived in the accurate order and earliest out of the first relay path and the second relay path. The frame selection unit 2018 employs the synchronization group in the first relay path based on continuity of the arriving synchronization frame F1. The frame selection unit 2018 determines not to employ the synchronization group in the second relay path and deletes the frames constituting the synchronization group in the second relay path. The same applies to values one, two, five, and eight of the synchronization frame identifiers.

For the value three of the synchronization frame identifier, the synchronization group in the first relay path has arrived earlier than the synchronization group in the second relay path. The synchronization group in the first relay path is a synchronization group in an inaccurate order in which a frame loss of the synchronization frame F1 has occurred. The synchronization group in the second relay path is a synchronization group in an accurate order in which no frame loss has occurred. Thus, the synchronization group in the second relay path is a synchronization group in the relay path through which frames have arrived in an accurate order and earliest out of the first relay path and the second relay path. The frame selection unit 2018 employs the synchronization group in the second relay path and recovers the synchronization frame F1 that has been lost in the first relay path. The frame selection unit 2018 determines not to employ the synchronization group in the first relay path and deletes the frames constituting the synchronization group in the first relay path.

For the value four of the synchronization frame identifier, the synchronization group in the first relay path has arrived earlier than the synchronization group in the second relay path. The synchronization group in the first relay path is a synchronization group in an inaccurate order in which a frame loss of the user frame F2 has occurred. The synchronization group in the second relay path is a synchronization group in an accurate order in which no frame loss has occurred. Thus, the synchronization group in the second relay path is a synchronization group in the relay path through which frames have arrived in an accurate order and earliest out of the first relay path and the second relay path. The frame selection unit 2018 employs the synchronization group in the second relay path and recovers the synchronization frame F1 that has been lost in the first relay path. The frame selection unit 2018 determines not to employ the synchronization group in the first relay path and deletes the frames constituting the synchronization group in the first relay path.

For the value six of the synchronization frame identifier, the synchronization group in the first relay path has arrived earlier than the synchronization group in the second relay path. The synchronization group in the first relay path is a synchronization group in an accurate order in which no frame loss has occurred. The synchronization group in the second relay path is a synchronization group in an inaccurate order in which a frame loss of the synchronization frame F1 has occurred. Thus, the synchronization group in the first relay path is the synchronization group in the relay path through which the frames have arrived in the accurate order and earliest out of the first relay path and the second relay path. The frame selection unit 2018 employs the synchronization group in the first relay path. The frame selection unit 2018 determines not to employ the synchronization group in the second relay path and deletes the frames constituting the synchronization group in the second relay path.

For the value seven of the synchronization frame identifier, the synchronization group in the first relay path has arrived earlier than the synchronization group in the second relay path. The synchronization group in the first relay path is a synchronization group in an accurate order in which no frame loss has occurred. The synchronization group in the second relay path is a synchronization group in an inaccurate order in which a frame loss of the user frame F2 has occurred. Thus, the synchronization group in the first relay path is the synchronization group in the relay path through which the frames have arrived in the accurate order and earliest out of the first relay path and the second relay path. The frame selection unit 2018 employs the synchronization group in the first relay path. The frame selection unit 2018 determines not to employ the synchronization group in the second relay path and deletes the frames constituting the synchronization group in the second relay path.

In this manner, the frame selection unit 2018 employs the synchronization group in the second relay path for the values three and four of the synchronization frame identifiers. The frame selection unit 2018 employs the synchronization group in the first relay path for the values of the synchronization frame identifiers other than three and four. The frame selection unit 2018 configures a frame sequence from each employed synchronization group.

### Actions and Effects

As described above, the uninterrupted apparatus embeds synchronization frame identifiers in synchronization frames and transmits a frame sequence constituted by the plurality of synchronization frames and a plurality of user frames via a plurality of relay paths in the first embodiment. The uninterrupted apparatus employs a synchronization group in the relay path through which frames have arrived in the accurate order determined based on the synchronization frame identifiers and earliest from among the plurality of relay paths, for the plurality of frame sequences via the plurality of relay paths.

In this manner, it is possible to enable determination of a frame loss without adding any information such as sequence numbers to the user frames. It is possible to realize lossless communication by establishing synchronization with a redundant path and securing redundancy. Because information such as sequence numbers is not applied to the user frames, the user frames can be received at a single base at which no dedicated apparatus is installed. It is possible to allow both bases at which dedicated apparatuses are installed and bases at which no dedicated apparatuses are installed to be present together and thereby to enlarge a network range to be applied to users. Because a redundant path and a dedicated apparatus are not needed at a single base, it is also possible to reduce line cost and apparatus cost.

### Second Embodiment

In the second embodiment, the same reference signs will be applied to components that may be similar to those in the first embodiment, and description thereof will be omitted. Components that are different from those in the first embodiment will be mainly described in the second embodiment.

### Configuration Example

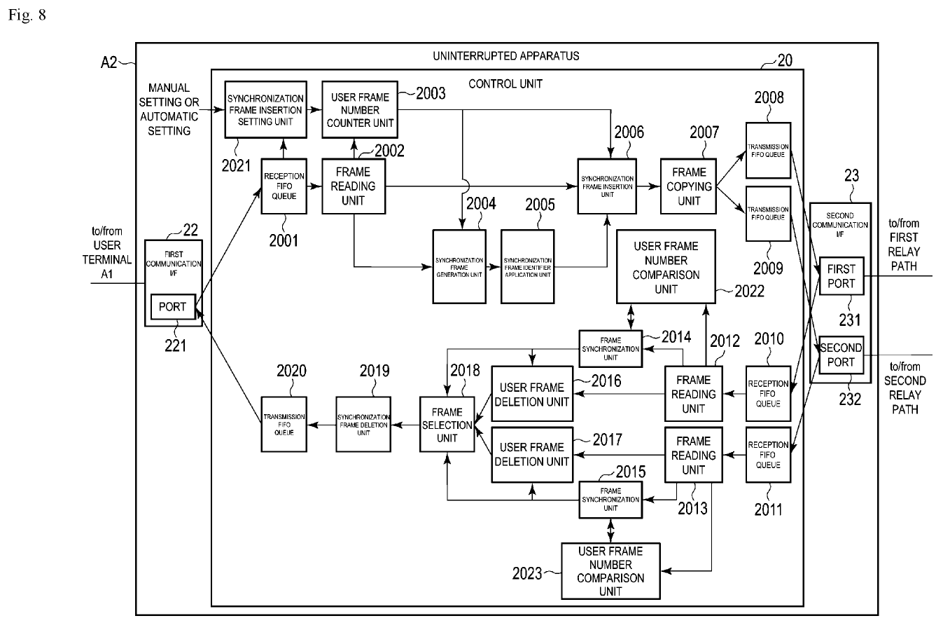

FIG. 8 is a block diagram illustrating a software configuration of the uninterrupted apparatus A2.

The control unit 20 executes a synchronization frame insertion setting unit 2021, a user frame number comparison unit 2022, and a user frame number comparison unit 2023 in addition to the components described in the first embodiment. The synchronization frame insertion setting unit 2021 is related to transmission processing. The user frame number comparison unit 2022 and the user frame number comparison unit 2023 are related to reception processing.

The synchronization frame insertion setting unit 2021 sets a setting value of the number of user frames F2 included in a synchronization group represented as one block of user information. The setting value is a positive integer value.

The user frame number comparison unit 2022 counts the user frames F2 included between the synchronization frame F1 and the next synchronization frame F1 via the first relay path, which are read by the frame reading unit 2012. The user frame number comparison unit 2022 compares the number of user frames F2 included between the synchronization frame F1 and the next synchronization frame F1 with the setting value. The user frame number comparison unit 2023 counts the user frames F2 included between the synchronization frame F1 and the next synchronization frame F1 via the second relay path, which are read by the frame reading unit 2013. The user frame number comparison unit 2023 compares the number of user frames F2 included between the synchronization frame F1 and the next synchronization frame F1 with the setting value.

Note that the user frame number comparison unit 2022 and the user frame number comparison unit 2023 may be collectively referred to as a user frame number comparison unit.

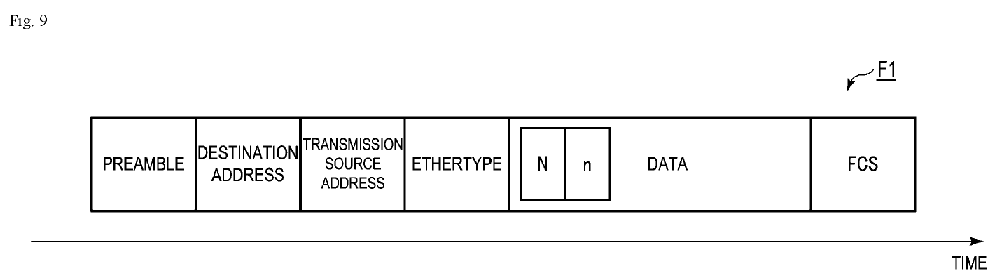

FIG. 9 is a diagram illustrating a configuration of a synchronization frame F1. The setting value is embedded in the data field similarly to the synchronization frame identifier. “n” is the setting value.

### Operation Example

Operations executed by the uninterrupted apparatus A2 configured as described above will be described.

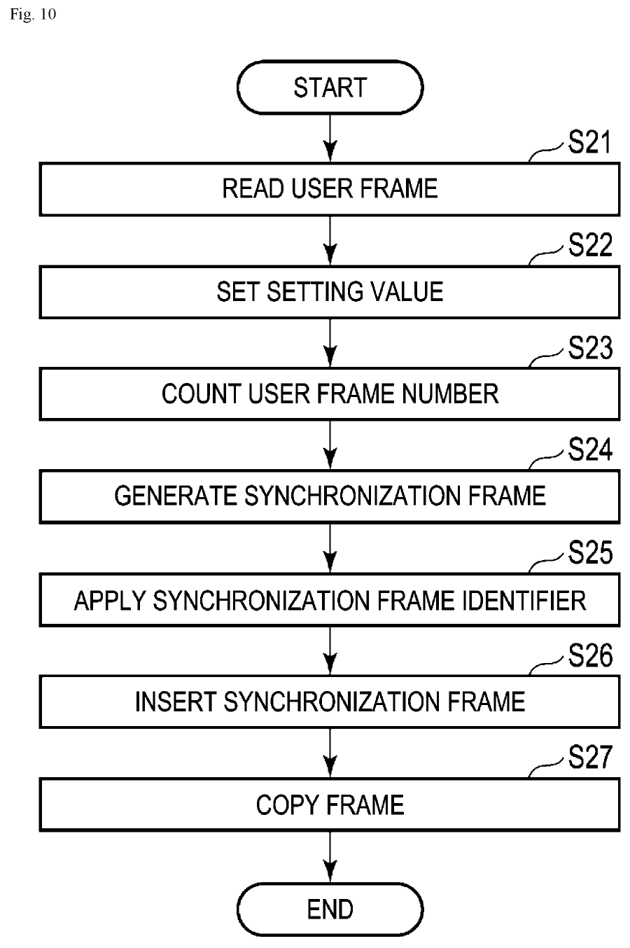

FIG. 10 is a flowchart illustrating a processing procedure and processing content of the transmission processing performed by the uninterrupted apparatus A2. Here, transmission processing in which the uninterrupted apparatus A2 transmits the same frame sequence to the uninterrupted apparatus B2 via both the first relay path and the second relay path will be described as an example.

The frame reading unit 2002 reads the user frames F2 input to the reception FIFO queue 2001 in order from the reception FIFO queue 2001 in the input order (Step S21). In Step S21, the frame reading unit 2002 reads the user frames F2 from the user terminal A1 in order, for example.

The synchronization frame insertion setting unit 2021 sets a setting value (Step S22). In Step S22, the synchronization frame insertion setting unit 2021 sets the setting value through a manual input of a finite integer value, for example. Instead, the synchronization frame insertion setting unit 2021 sets a value automatically calculated to obtain equal intervals between the synchronization frames F1 as the setting value, for example.

The user frame number counter unit 2003 counts the number of user frames F2 read by the frame reading unit 2002 (Step S23). In Step S23, the user frame number counter unit 2003 counts the number of user frames F2 read by the frame reading unit 2002 up to the setting value set by the synchronization frame insertion setting unit 2021, for example.

The synchronization frame generation unit 2004 generates a synchronization frame for each synchronization group (Step S24). In Step S24, the synchronization frame generation unit 2004 generates the synchronization frame F1 for each synchronization group including the user frames F2 of the number corresponding to the setting value counted by the user frame number counter unit 2003. The synchronization frame generation unit 2004 embeds the setting value in the synchronization frame F1. The synchronization frame generation unit 2004 embeds one setting value for each synchronization frame F1.

The synchronization frame identifier application unit 2005 applies the synchronization frame identifier to each synchronization frame F1 generated by the synchronization frame generation unit 2004 and embeds the synchronization frame identifier in the synchronization frame F1 (Step S25). In Step S25, the synchronization frame identifier application unit 2005 applies the value N of the synchronization frame identifier to each synchronization frame F1 in order from zero every time the synchronization frame generation unit 2004 generates the synchronization frame F1, for example. The synchronization frame identifier application unit 2005 embeds one synchronization frame identifier in each synchronization frame F1.

The synchronization frame insertion unit 2006 inserts the synchronization frame F1 with the setting value and the synchronization frame identifier embedded therein between two successive user frames F2 (Step S26). In Step S26, the synchronization frame insertion unit 2006 inserts the synchronization frame F1 into a point immediately before the first (head) user frame F2 included in the synchronization group associated with the synchronization frame F1, for example. The first user frame F2 is a user frame F2 that comes first in the sending order among the user frames F2 of the number corresponding to the setting value included in the synchronization group. In other words, the synchronization frame insertion unit 2006 inserts the synchronization frame F1 between two successive user frames F2 such that the synchronization frame F1 and the user frames F2 of the number corresponding to the setting value are alternately arranged. The one synchronization frame F1 and the user frames F2 of the number corresponding to the setting value immediately after the synchronization frame F1 constitute a synchronization group.

The frame copying unit 2007 copies synchronization frames F1 and user frame F2 (Step S27). In Step S27, the frame copying unit 2007 copies the user frames F2 read by the frame reading unit 2002 and the synchronization frames F1 inserted by the synchronization frame insertion unit 2006, for example. The frame copying unit 2007 copies a frame sequence constituted by a plurality of synchronization frames F1 and a plurality of user frames F2. The frame copying unit 2007 outputs the copied synchronization frames F1 and user frames F2 to a plurality of transmission FIFO queues corresponding to a plurality of output ports. The frame copying unit 2007 outputs the copied synchronization frame F1 and the user frame F2 to the transmission FIFO queue 2008 and the transmission FIFO queue 2009 corresponding to a first port 231 and a second port 232 of the second communication I/F 23. The frame copying unit 2007 outputs the same frame sequence constituted by the copied plurality of synchronization frames F1 and plurality of user frames F2 to the transmission FIFO queue 2008 and the transmission FIFO queue 2009. In this manner, the same frame sequence is transmitted from the uninterrupted apparatus A2 to the uninterrupted apparatus B2 via both the first relay path and the second relay path.

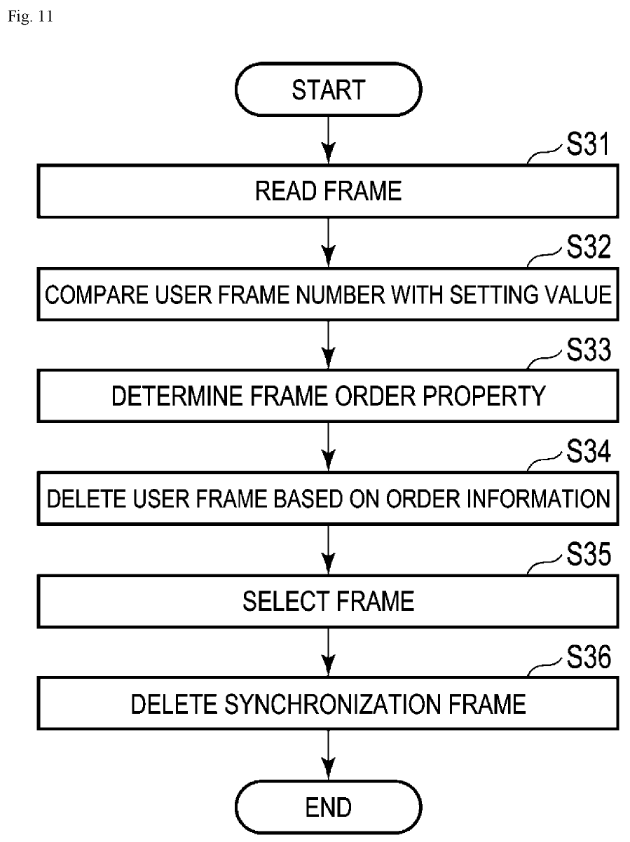

FIG. 11 is a flowchart illustrating a processing procedure and processing content of reception processing performed by the uninterrupted apparatus A2. Here, reception processing in which the uninterrupted apparatus A2 receives the same frame sequence from the uninterrupted apparatus B2 via both the first relay path and the second relay path will be described as an example.

The frame reading unit 2012 and the frame reading unit 2013 read synchronization frames F1 and user frames F2 with synchronization frame identifiers and setting values embedded therein, which have been input from the plurality of relay paths to each of the plurality of reception FIFO queues in order (Step S31) In Step S31, the frame reading unit 2012 reads any of the synchronization frames F1 and the user frames F2 input in order from the first relay path to the reception FIFO queue 2010 from the reception FIFO queue 2010 in the input order, for example. The frame reading unit 2013 reads, from the reception FIFO queue 2011 in the input order, any of the synchronization frames F1 and the user frames F2 input from the second relay path to the reception FIFO queue 2011 in order.

The user frame number comparison unit 2022 and the user frame number comparison unit 2023 compare the numbers of user frames F2 with the setting values for each of the plurality of relay paths (Step S32). In Step S32, the user frame number comparison unit 2022 counts the user frames F2 included between the synchronization frame F1 and the next synchronization frame F1 for each synchronization frame F1 via the first relay path, which has been read by the frame reading unit 2012, for example. The user frame number comparison unit 2022 compares the number of user frames F2 included between the synchronization frame F1 and the next synchronization frame F1 with the setting value read from the synchronization frame F1 by the frame synchronization unit 2014. In a case where the number of user frames F2 matches the setting value, the user frame number comparison unit 2022 determines that the order of the user frames F2 matches. The fact that the order of the user frames F2 matches corresponds to a fact that the number of the user frames F2 matches the setting value. In a case where the number of user frames F2 does not match the setting value, the user frame number comparison unit 2022 determines that the order of the user frames F2 does not match. The fact that the order of the user frames F2 does not match corresponds to a fact that the number of user frames F2 does not match the setting value. The user frame number comparison unit 2022 sends, to the frame synchronization unit 2014, information indicating whether the order of the user frames F2 matches or does not match, for each synchronization group identified with the value N of the synchronization frame identifier of the synchronization frame F1. The user frame number comparison unit 2023 counts the user frames F2 included between the synchronization frame F1 and the next synchronization frame F1 for each synchronization frame F1 via the second relay path, which has been read by the frame reading unit 2013. The user frame number comparison unit 2023 compares the number of user frames F2 included between the synchronization frame F1 and the next synchronization frame F1 with the setting value read from the synchronization frame F1 by the frame synchronization unit 2015. In a case where the number of user frames F2 matches the setting value, the user frame number comparison unit 2023 determines that the order of the user frames F2 matches. In a case where the number of user frames F2 does not match the setting value, the user frame number comparison unit 2023 determines the order of the user frames F2 does not matches. The user frame number comparison unit 2023 sends, to the frame synchronization unit 2015, information indicating whether the order of the user frames F2 matches or does not match, for each synchronization group identified with the value N of the synchronization frame identifier of the synchronization frame F1.

The frame synchronization unit 2014 and the frame synchronization unit 2015 determines the order property of the frames via the plurality of relay paths (Step S33). In Step S33, the frame synchronization unit 2014 recognizes the order property of the synchronization frames F1 based on the synchronization frame identifiers of the synchronization frames F1 via the first relay path, which have been read by the frame reading unit 2012, for example. The frame synchronization unit 2014 determines whether or not the order property of the synchronization frames F1 is accurate. The frame synchronization unit 2014 determines that the order property of the user frames F2 constituting the synchronization group identified with the value N of the synchronization frame identifier associated with information from the user frame number comparison unit 2022 indicating that the order of the user frames F2 matches is correct, based on the information. On the other hand, the frame synchronization unit 2014 determines that the order property of the user frames F2 constituting the synchronization group identified by the value N of the synchronization frame identifier associated with information from the user frame number comparison unit 2022 indicating that the order of the user frame F2 does not match is not accurate, based on the information. The frame synchronization unit 2014 generates order information for each synchronization group identified with the value N of the synchronization frame identifier. The order information can include information indicating whether or not the order property of the synchronization frame F1 included in the synchronization group is accurate. The order information can include the value N of the synchronization frame identifier of the synchronization frame F1 included in the synchronization group. The order information can include information indicating that the order of the user frames F2 included in the synchronization group matches or does not match. The fact that the order of the user frames F2 matches corresponds to a fact that the order property of the user frames F2 is accurate and also corresponds to a fact that no frame loss has occurred in the user frame sequence included in the synchronization group. The fact that the order of the user frames F2 does not match corresponds to a fact that the order property of the user frames F2 is not accurate and also corresponds to a fact that a frame loss has occurred in the user frame sequence included in the synchronization group.

The frame synchronization unit 2015 recognizes the order property of the synchronization frames F1 based on the synchronization frame identifiers of the synchronization frames F1 via the second relay path, which have been read by the frame reading unit 2013. The frame synchronization unit 2015 determines whether or not the order property of the synchronization frames F1 is correct. The frame synchronization unit 2015 determines that the order property of the user frames F2 constituting the synchronization group identified with the value N of the synchronization frame identifier associated with information from the user frame number comparison unit 2023 indicating that the order of the user frames F2 matches is accurate, based on the information. On the other hand, the frame synchronization unit 2015 determines that the order property of the user frames F2 constituting the synchronization group identified with the value N of the synchronization frame identifier associated with information from the user frame number comparison unit 2023 indicating that the order of the user frames F2 does not match is not correct, based on the information. The frame synchronization unit 2015 generates order information for each synchronization group identified with the value N of the synchronization frame identifier. The frame synchronization unit 2015 generates order information for each synchronization group identified with the value N of the synchronization frame identifier. The order information can include information indicating whether or not the order property of the synchronization frame F1 included in the synchronization group is accurate. The order information can include the value N of the synchronization frame identifier of the synchronization frame F1 included in the synchronization group. The order information can include information indicating that the order of the user frames F2 included in the synchronization group matches or does not match.

The user frame deletion unit 2016 and the user frame deletion unit 2017 delete the user frames F2 via the plurality of relay paths as needed based on the order information from the frame synchronization unit 2014 and the frame synchronization unit 2015 (Step S34). In Step S34, in a case where the order information from the frame synchronization unit 2014 includes information indicating that the order of the user frames F2 does not match, for example, the user frame deletion unit 2016 deletes the user frames F2 included between the synchronization frame F1 associated with the order information and the next synchronization frame F1. On the other hand, in a case where the order information from the frame synchronization unit 2014 includes information indicating that the order of the user frames F2 matches, the user frame deletion unit 2016 does not delete the user frames F2 included between the synchronization frame F1 associated with the order information and the next synchronization frame F1. In a case where the order information from the frame synchronization unit 2015 includes information indicating that the order of the user frames F2 does not match, the user frame deletion unit 2017 deletes the user frames F2 included between the synchronization frame F1 associated with the order information and the next synchronization frame F1. On the other hand, in a case where the order information from the frame synchronization unit 2015 includes information indicating that the order of the user frames F2 matches, the user frame deletion unit 2017 does not delete the user frames F2 included between the synchronization frame F1 associated with the order information and the next synchronization frame F1.

The frame selection unit 2018 employs a synchronization group constituted by one synchronization frame F1 and user frames F2 of the number corresponding to the setting value associated with the synchronization frame F1 in a relay path through which frames have arrived in the accurate order determined based on the synchronization frame identifier and the setting value and earliest out of the first relay path and the second relay path (Step S35). In Step S35, the frame selection unit 2018 employs a synchronization group that is in an accurate order and that is in a relay path through which frames have arrived earliest out of the first relay path and the second relay path, for each value N of the synchronization frame identifier based on the order information from the frame synchronization unit 2014 and the order information from the frame synchronization unit 2015, for example.

In regard to a value N for a certain synchronization frame identifier, for example, it is assumed that the order information from the frame synchronization unit 2014 includes information indicating that the order of the user frames F2 matches and information indicating that the order property of the synchronization frame F1 is accurate. It is assumed that the order information from the frame synchronization unit 2015 includes information indicating that the order of the user frames F2 matches and information indicating that the order property of the synchronization frame F1 is accurate. The frame selection unit 2018 determines that the synchronization frame F1 and the user frames F2 of the number corresponding to the setting value, which constitute the synchronization group in the first relay path, are in the accurate order based on the order information from the frame synchronization unit 2014. Because the order information from the frame synchronization unit 2014 is generated based on the synchronization frame identifier and the setting value, it is possible to state that the frame selection unit 2018 determines that the order is accurate based on the synchronization frame identifier and the setting value. The frame selection unit 2018 determines that the order of the synchronization frame F1 and the user frames F2 of the number corresponding to the setting value, which constitute the synchronization group in the second relay path, is accurate based on the order information from the frame synchronization unit 2015. Because the order information from the frame synchronization unit 2015 is generated based on the synchronization frame identifier and the setting value, the frame selection unit 2018 can determine if the order is accurate based on the synchronization frame identifier and the setting value. The frame selection unit 2018 employs a synchronization group in a relay path through which the frames have arrived in the accurate order and earliest out of the first relay path and the second relay path. The synchronization group in the first relay path is constituted by one synchronization frame F1 read by the frame reading unit 2012 and user frames F2 of the number corresponding to the setting value, which have not been deleted by the user frame deletion unit 2016. The synchronization group in the second relay path is constituted by one synchronization frame F1 read by the frame reading unit 2013 and user frames F2 of the number corresponding to the setting value, which have not been deleted by the user frame deletion unit 2017. The frame selection unit 2018 deletes frames constituting the synchronization group in the relay path that is not employed out of the first relay path and the second relay path.

In regard to a value N for a certain synchronization frame identifier, for example, it is assumed that the order information from the frame synchronization unit 2014 includes information indicating that the order of the user frames F2 matches and information indicating that the order property of the synchronization frame F1 is accurate. It is assumed that the order information from the frame synchronization unit 2015 includes information indicating that the order of the user frames F2 does not match and information indicating that the order property of the synchronization frame F1 is accurate. The frame selection unit 2018 determines that the synchronization frame F1 and the user frames F2 of the number corresponding to the setting value, which constitute the synchronization group in the first relay path, are in the accurate order based on the order information from the frame synchronization unit 2014. The frame selection unit 2018 determines that the frames constituting the synchronization group in the second relay path are in an inaccurate order, based on the order information from the frame synchronization unit 2015. Because the order information from the frame synchronization unit 2015 is generated based on the synchronization frame identifier and the setting value, it is possible to state that the frame selection unit 2018 determines that the order is not accurate based on the synchronization frame identifier and the setting value. In this example, the synchronization group in the first relay path is the synchronization group of the relay path through which the frames have arrived in the accurate order and earliest out of the first relay path and the second relay path. The frame selection unit 2018 employs the synchronization group in the first relay path. The frame selection unit 2018 does not employ the synchronization group in the second relay path. The frame selection unit 2018 deletes the frames constituting the synchronization group in the second relay path that is not employed.

In regard to the value N of a certain synchronization frame identifier, for example, it is possible to state the order information from the frame synchronization unit 2014 includes information indicating that the order of the user frames F2 does not match and information indicating that the order property of the synchronization frame F1 is accurate. It is assumed that the order information from the frame synchronization unit 2015 includes information indicating that the order of the user frames F2 matches and information indicating that the order property of the synchronization frame F1 is accurate. The frame selection unit 2018 determines that the frames constituting the synchronization group in the first relay path are in an inaccurate order, based on the order information from the frame synchronization unit 2014. The frame selection unit 2018 determines that the order of the synchronization frame F1 and the user frames F2 of the number corresponding to the setting value, which constitute the synchronization group in the second relay path, is accurate based on the order information from the frame synchronization unit 2015. In this example, the synchronization group in the second relay path is a synchronization group in the relay path through which frames have arrived in the accurate order and earliest out of the first relay path and the second relay path. The frame selection unit 2018 employs the synchronization group in the second relay path. The frame selection unit 2018 does not employ the synchronization group in the first relay path. The frame selection unit 2018 deletes frames constituting the synchronization group in the first relay path that is not employed.

The synchronization frame deletion unit 2019 deletes the synchronization frame F1 out of the synchronization frame F1 and the user frames F2 included in the synchronization group employed by the frame selection unit 2018 (Step S36). In Step S36, the synchronization frame deletion unit 2019 deletes the synchronization frame F1 for each synchronization group employed by the frame selection unit 2018 in the accurate order identified with the synchronization frame identifier. On the other hand, the synchronization frame deletion unit 2019 outputs the user frame F2 out of the synchronization frame F1 and the user frame F2 included in the synchronization group employed by the frame selection unit 2018 to the transmission FIFO queue 2020. In this manner, the synchronization frame deletion unit 2019 outputs the user frame F2 of each synchronization group selected by the frame selection unit 2018 to the transmission FIFO queue 2020. A frame sequence constituted by a plurality of user frames F2 is transmitted to the user terminal A1.

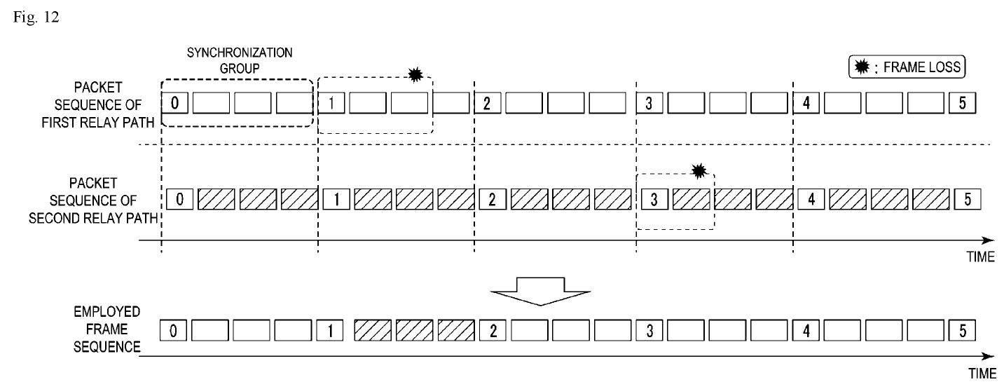

FIG. 12 is a diagram illustrating a frame sequence employed in reception processing performed by the uninterrupted apparatus A2.

The frame sequence via the first relay path is assumed to arrive at the uninterrupted apparatus A2 earlier than the frame sequence via the second relay path. The setting value n embedded in each synchronization frame F1 is assumed to be three.

The frame selection unit 2018 employs the synchronization group in the relay path through which frames have arrived in the accurate order and earliest out of the first relay path and the second relay path, in order from the value zero of the synchronization frame identifier.

For the value zero of the synchronization frame identifier, both the synchronization group in the first relay path and the synchronization group in the second relay path are synchronization groups in accurate orders. The synchronization group in the first relay path has arrived earlier than the synchronization group in the second relay path. Thus, the synchronization group in the first relay path is the synchronization group in the relay path through which the frames have arrived in the accurate order and earliest out of the first relay path and the second relay path. The frame selection unit 2018 employs the synchronization group in the first relay path based on continuity of the arriving synchronization frame F1. The frame selection unit 2018 determines not to employ the synchronization group in the second relay path and deletes the frames constituting the synchronization group in the second relay path. The same applies to the values two and four of the synchronization frame identifiers.

For the value one of the synchronization frame identifier, the synchronization group in the first relay path has arrived earlier than the synchronization group in the second relay path, The synchronization group in the first relay path is a synchronization group in an inaccurate order in which frame losses of the synchronization frame F1 and two user frames F2 have occurred. The synchronization group in the second relay path is a synchronization group in an accurate order in which no frame loss has occurred. Thus, the synchronization group in the second relay path is a synchronization group in the relay path through which frames have arrived in an accurate order and earliest out of the first relay path and the second relay path. The frame selection unit 2018 employs the synchronization group in the second relay path and recovers the synchronization frame F1 that has been lost in the first relay path. The frame selection unit 2018 determines not to employ the synchronization group in the first relay path and deletes the frames constituting the synchronization group in the first relay path.

For the value three of the synchronization frame identifier, the synchronization group in the first relay path has arrived earlier than the synchronization group in the second relay path. The synchronization group in the first relay path is a synchronization group in an accurate order in which no frame loss has occurred. The synchronization group in the second relay path is a synchronization group in an inaccurate order in which frame losses of the synchronization frame F1 and one user frame F2 have occurred. Thus, the synchronization group in the first relay path is the synchronization group in the relay path through which the frames have arrived in the accurate order and earliest out of the first relay path and the second relay path. The frame selection unit 2018 employs the synchronization group in the first relay path. The frame selection unit 2018 determines not to employ the synchronization group in the second relay path and deletes the frames constituting the synchronization group in the second relay path.

In this manner, the frame selection unit 2018 employs the synchronization group in the second relay path for the value one of the synchronization frame identifier. The frame selection unit 2018 employs the synchronization group in the first relay path for values of the synchronization frame identifiers other than one. The frame selection unit 2018 configures a frame sequence from each employed synchronization group.

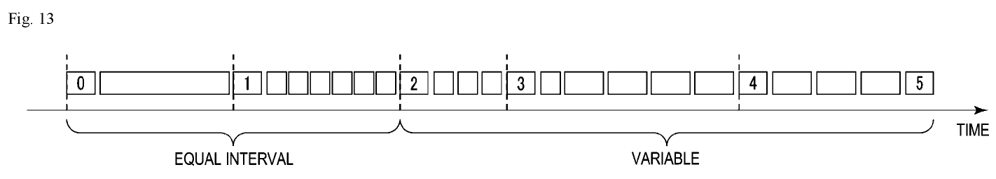

FIG. 13 is a diagram illustrating a frame sequence in transmission processing performed by the uninterrupted apparatus A2.

The intervals between the synchronization frames F1 may be equal intervals or may be variable.

The number of user frames F2 included between the synchronization frames F1 may be the same or different.

### Actions and Effects

As described above, the uninterrupted apparatus embeds the synchronization frame identifier and the setting value in the synchronization frame and transmits a frame sequence constituted by a plurality of synchronization frames and a plurality of user frames via a plurality of relay paths in the second embodiment. The uninterrupted apparatus employs the synchronization group in the relay path through which frames have arrived in the accurate order determined based on the synchronization frame identifier and the setting value and earliest from among the plurality of relay paths, for the plurality of frame sequences via the plurality of relay paths.

In this manner, it is possible to transfer user frames of any number corresponding to the setting value for one synchronization frame and thereby to improve transmission efficiency of the user frames.

### Third Embodiment

In the third embodiment, the same reference signs will be applied to components that may be similar to those in the first embodiment or the second embodiment, and description thereof will be omitted. In the third embodiment, components that are different from those in the first embodiment or the second embodiment will be mainly described.

### Configuration Example

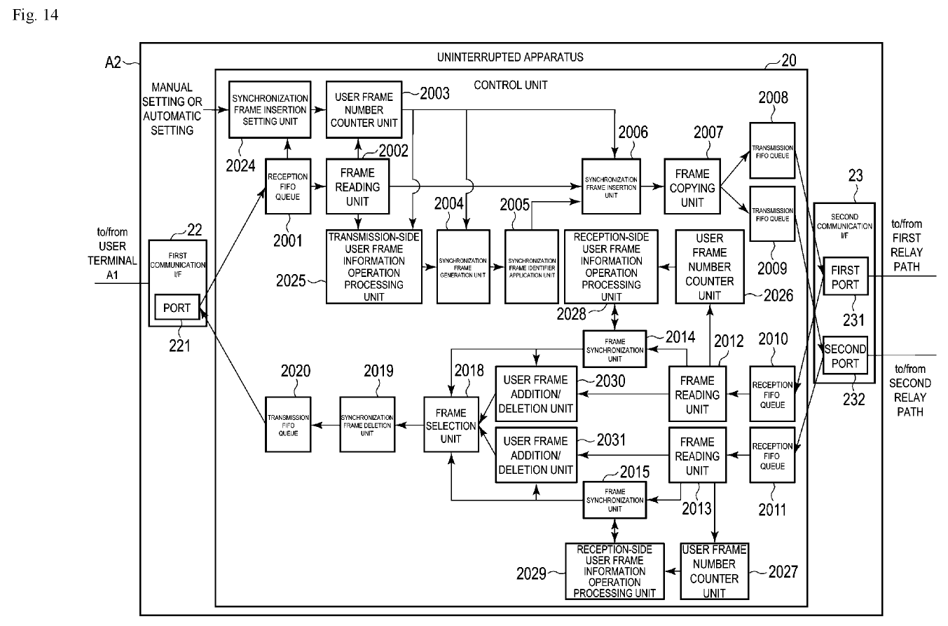

FIG. 14 is a block diagram illustrating a software configuration of the uninterrupted apparatus A2.

The control unit 20 executes a synchronization frame insertion setting unit 2024, a transmission-side user frame information operation processing unit 2025, a user frame number counter unit 2026, a user frame number counter unit 2027, a reception-side user frame information operation processing unit 2028, and a reception-side user frame information operation processing unit 2029 in addition to each component described in the first embodiment. The control unit 20 executes a user frame addition/deletion unit 2030 and a user frame addition/deletion unit 2031 instead of the user frame deletion unit 2016 and the user frame deletion unit 2017 described in the first embodiment. The synchronization frame insertion setting unit 2024 and the transmission-side user frame information operation processing unit 2025 are related to transmission processing. The user frame number counter unit 2026, the user frame number counter unit 2027, the reception-side user frame information operation processing unit 2028, the reception-side user frame information operation processing unit 2029, the user frame addition/deletion unit 2030, and the user frame addition/deletion unit 2031 are related to reception processing.

The synchronization frame insertion setting unit 2024 sets the setting value of the number of user frames F2 included in the synchronization group represented as one block of user information similarly to the synchronization frame insertion setting unit 2021. The setting value is a positive integer value.

The transmission-side user frame information operation processing unit 2025 generates transmission-side operational information. The transmission-side operational information is information in which first individual information as a part of each of user frames F2 of the number corresponding to the setting value set by the synchronization frame insertion setting unit 2024 is aligned in order. The first individual information is information (transmission information) indicating content of the user frame F2 For example, although the first individual information is information as a part of the FCS field or the DATA field of the user frame F2, it is only necessary for the first individual information to be information as a part of the user frame F2, and the first individual information is not limited thereto. The first individual information is, for example, cyclic redundancy check (CRC).

The user frame number counter unit 2026 counts the user frames F2 included between the synchronization frame F1 and the next synchronization frame F1 via the first relay path read by the frame reading unit 2012.

The user frame number counter unit 2027 counts the user frames F2 included between the synchronization frame F1 and the next synchronization frame F1 via the second relay path read by the frame reading unit 2013.

Note that the user frame number counter unit 2026 and the user frame number counter unit 2027 may be collectively referred to as a user frame number counter unit.

The reception-side user frame information operation processing unit 2028 generates reception-side operational information. The reception-side operational information is information in which second individual information as a part of each user frame F2 counted by the user frame number counter unit 2026 is aligned in order. The second individual information is information indicating content of the user frame F2 similarly to the first individual information. The second individual information can be information regarding the same part as that of the first individual information in the user frame F2. For example, the second individual information is information as a part of the FCS field or the DATA field of the user frame F2 similarly to the first individual information.

The reception-side user frame information operation processing unit 2029 generates reception-side operational information. The reception-side operational information is information in which second individual information as a part of each user frame F2 counted by the user frame number counter unit 2027 is aligned in order.

Note that the reception-side user frame information operation processing unit 2028 and the reception-side user frame information operation processing unit 2029 may be collectively referred to as a reception-side user frame information operation processing unit.

The user frame addition/deletion unit 2030 deletes the user frames F2 via the first relay path read by the frame reading unit 2012 as needed based on the order information from the frame synchronization unit 2014. The user frame addition/deletion unit 2030 adds (padding) a dummy frame to the synchronization group as needed based on the order information from the frame synchronization unit 2014.

The user frame addition/deletion unit 2031 deletes the user frames F2 via the second relay path read by the frame reading unit 2013 as needed based on the order information from the frame synchronization unit 2015. The user frame addition/deletion unit 2031 adds (padding) a dummy frame to the synchronization group as needed based on the order information from the frame synchronization unit 2015.

Note that the user frame addition/deletion unit 2030 and the user frame addition/deletion unit 2031 may be collectively referred to as a user frame addition/deletion unit.

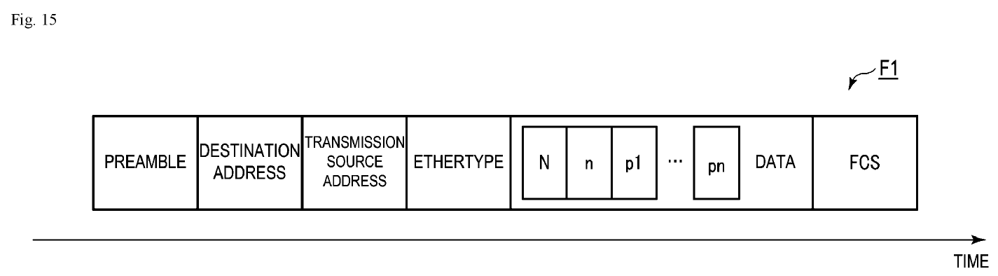

FIG. 15 is a diagram illustrating a configuration of a synchronization frame F1. The transmission-side operational information is embedded in the data field similarly to the synchronization frame identifier and the setting value. The transmission-side operational information is information in which first individual information p1 to pn (n is a number corresponding to the setting value) is aligned in order. For example, the transmission-side operational information is information in which the first individual information p1 to pn related to each user frame F2 are aligned in the order of the user frames F2 input to the reception FIFO queue 2001. The number of pieces of first individual information p1 to pn corresponds to the number off user frames F2 included in the synchronization group.

### Operation Example

Operations executed by the uninterrupted apparatus A2 configured as described above will be described.

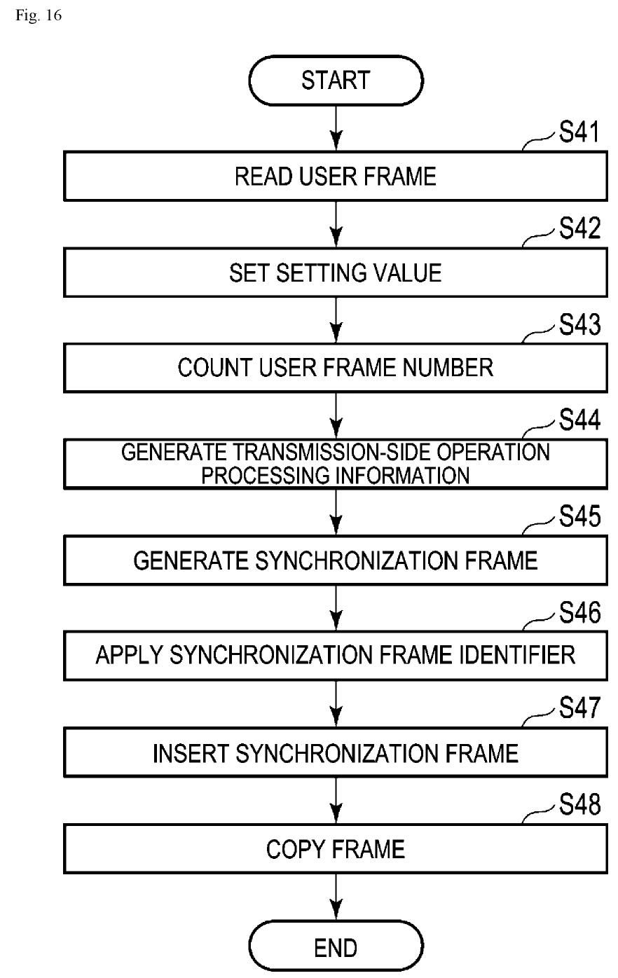

FIG. 16 is a flowchart illustrating a processing procedure and processing content of transmission processing performed by the uninterrupted apparatus A2. Here, transmission processing in which the uninterrupted apparatus A2 transmits the same frame sequence to the uninterrupted apparatus B2 via both the first relay path and the second relay path will be described as an example.

The frame reading unit 2002 reads the user frames F2 input to the reception FIFO queue 2001 in order from the reception FIFO queue 2001 in the input order (Step S41). In Step S41, the frame reading unit 2002 reads the user frames F2 from the user terminal A1 in order, for example.

The synchronization frame insertion setting unit 2024 sets the setting value (Step S42). In Step S42, the synchronization frame insertion setting unit 2024 sets the setting value through a manual input of a finite integer value, for example. Instead, the synchronization frame insertion setting unit 2024 sets, as a setting value, a value automatically calculated such that the intervals between the synchronization frames F1 are equal intervals, for example.

The user frame number counter unit 2003 counts the number of user frames F2 read by the frame reading unit 2002 (Step S43). In Step S43, the user frame number counter unit 2003 counts the number of user frames F2 read by the frame reading unit 2002 up to the setting value set by the synchronization frame insertion setting unit 2021, for example.

The transmission-side user frame information operation processing unit 2025 generates transmission-side operational information (Step S44). In Step S44, the transmission-side user frame information operation processing unit 2025 generates transmission-side operational information in which the first individual information p1 to pn as a part of each of user frames F2 of the number corresponding to the setting value set by the synchronization frame insertion setting unit 2024 is aligned in order, for example. The transmission-side user frame information operation processing unit 2025 acquires and aligns the first individual information p1 to pn related to each user frame F2 in the order of the user frames F2 input to the reception FIFO queue 2001. The order of the user frames F2 input to the reception FIFO queue 2001 corresponds to the order in which the user frames F2 are read by the frame reading unit 2002. The order of the user frames F2 input to the reception FIFO queue 2001 also corresponds to the order in which the user frames F2 are transmitted from the uninterrupted apparatus A2. The transmission-side user frame information operation processing unit 2025 generates transmission-side operational information for each synchronization group for each of the user frames F2 of the number corresponding to the setting value counted by the user frame number counter unit 2003.

The synchronization frame generation unit 2004 generates a synchronization frame for each synchronization group (Step S45). In Step S45, the synchronization frame generation unit 2004 generates the synchronization frame F1 for each synchronization group including the user frames F2 of the number corresponding to the setting value counted by the user frame number counter unit 2003. The synchronization frame generation unit 2004 embeds the setting value and the transmission-side operational information in the synchronization frame F1. The synchronization frame generation unit 2004 embeds one setting value and separate transmission-side operational information in each synchronization frame F1.

The synchronization frame identifier application unit 2005 applies the synchronization frame identifier to each synchronization frame F1 generated by the synchronization frame generation unit 2004 and embeds the synchronization frame identifier in the synchronization frame F1 (Step S46). In Step S46, the synchronization frame identifier application unit 2005 applies the value N of the synchronization frame identifier to each synchronization frame F1 in order from zero every time the synchronization frame generation unit 2004 generates the synchronization frame F1, for example. The synchronization frame identifier application unit 2005 embeds one synchronization frame identifier in each synchronization frame F1.

The synchronization frame insertion unit 2006 inserts the synchronization frame F1 with the setting value, the transmission-side operational information, and the synchronization frame identifier embedded therein between two successive user frames F2 (Step S47). In Step S47, the synchronization frame insertion unit 2006 inserts the synchronization frame F1 immediately before the first (head) user frame F2 included in the synchronization group associated with the synchronization frame F1, for example. The first user frame F2 is a user frame F2 that comes first in the sending order among the user frames F2 of the number corresponding to the setting value included in the synchronization group. In other words, the synchronization frame insertion unit 2006 inserts the synchronization frame F1 between two successive user frames F2 such that the synchronization frame F1 and the user frames F2 of the number corresponding to the setting value are alternately arranged. The one synchronization frame F1 and the user frames F2 of the number corresponding to the setting value immediately after the synchronization frame F1 constitute a synchronization group.

The frame copying unit 2007 copies synchronization frames F1 and user frames F2 (Step S48). In Step S48, the frame copying unit 2007 copies the user frames F2 read by the frame reading unit 2002 and the synchronization frames F1 inserted by the synchronization frame insertion unit 2006, for example. The frame copying unit 2007 copies a frame sequence constituted by a plurality of synchronization frames F1 and a plurality of user frames F2. The frame copying unit 2007 outputs the copied synchronization frames F1 and user frames F2 to a plurality of transmission FIFO queues corresponding to a plurality of output ports. The frame copying unit 2007 outputs the copied synchronization frame F1 and the user frame F2 to the transmission FIFO queue 2008 and the transmission FIFO queue 2009 corresponding to a first port 231 and a second port 232 of the second communication I/F 23. The frame copying unit 2007 outputs the same frame sequence constituted by the copied plurality of synchronization frames F1 and plurality of user frames F2 to the transmission FIFO queue 2008 and the transmission FIFO queue 2009. In this manner, the same frame sequence is transmitted from the uninterrupted apparatus A2 to the uninterrupted apparatus B2 via both the first relay path and the second relay path.

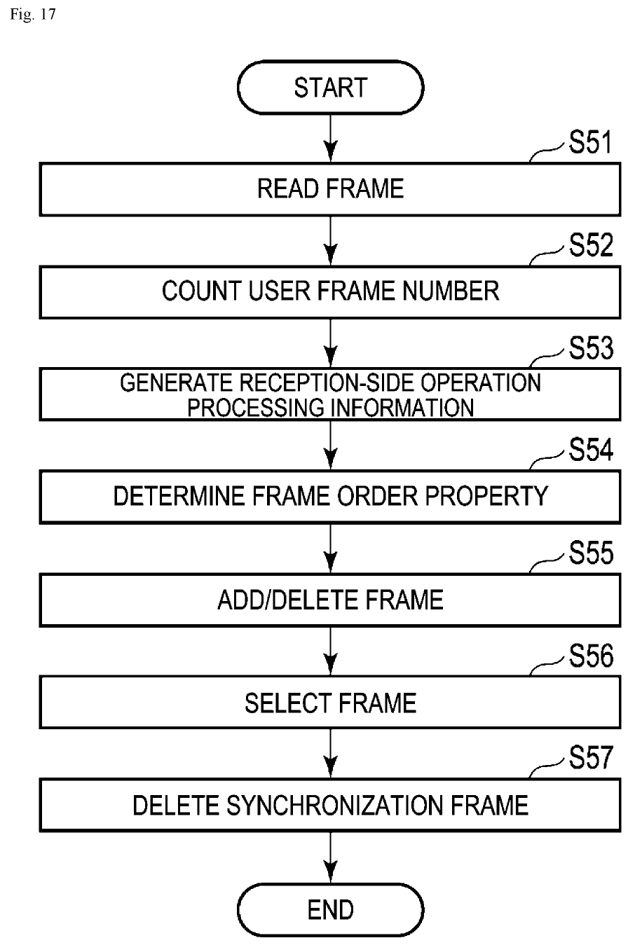

FIG. 17 is a flowchart illustrating a processing procedure and processing content of reception processing performed by the uninterrupted apparatus A2. Here, reception processing in which the uninterrupted apparatus A2 receives the same frame sequence from the uninterrupted apparatus B2 via both the first relay path and the second relay path will be described as an example.

The frame reading unit 2012 and the frame reading unit 2013 read the synchronization frames F1 in which the synchronization frame identifiers input from the plurality of relay paths to each of the plurality of reception FIFO queues in order, the setting values, and the transmission-side operational information are embedded and the user frames F2 (Step S51). In Step S51, the frame reading unit 2012 reads any of the synchronization frames F1 and the user frames F2 input in order from the first relay path to the reception FIFO queue 2010 from the reception FIFO queue 2010 in the input order, for example. The frame reading unit 2013 reads, from the reception FIFO queue 2011 in the input order, any of the synchronization frames F1 and the user frames F2 input from the second relay path to the reception FIFO queue 2011 in order.

The user frame number counter unit 2026 and the user frame number counter unit 2027 count the number of user frames F2 for each of the plurality of relay paths (Step S52). In Step S52, the user frame number counter unit 2026 counts the user frames F2 included between the synchronization frame F1 and the next synchronization frame F1 for each synchronization frame F1 via the first relay path, which has been read by the frame reading unit 2012, for example. In a case where no frame loss of the user frame F2 has occurred, the number of user frames F2 counted by the user frame number counter unit 2026 corresponds to the setting value. The user frame number counter unit 2027 counts the user frames F2 included between the synchronization frame F1 and the next synchronization frame F1 for each synchronization frame F1 via the second relay path, which has been read by the frame reading unit 2013. In a case where no frame loss of the user frame F2 has occurred, the number of user frames F2 counted by the user frame number counter unit 2027 corresponds to the setting value.

The reception-side user frame information operation processing unit 2028 and the reception-side user frame information operation processing unit 2029 generate reception-side operational information (Step S53). In Step S53, the reception-side user frame information operation processing unit 2028 generates reception-side operational information in which second individual information as a part of each of user frames F2 of the number counted by the user frame number counter unit 2026 is aligned in order, for example. The number of pieces of second individual information is a number corresponding to the setting value at maximum. The reception-side user frame information operation processing unit 2028 acquires and aligns the second individual information related to each user frame F2 in order of the user frames F2 input to the reception FIFO queue 2010. The order of the user frames F2 input to the reception FIFO queue 2010 corresponds to an order in which the user frames F2 are read by the frame reading unit 2012. The reception-side user frame information operation processing unit 2028 generates reception-side operational information for each synchronization group. The reception-side user frame information operation processing unit 2029 generates reception-side operational information in which second individual information as a part of each of user frames F2 of the number counted by the user frame number counter unit 2027 is aligned in order. The number of pieces of second individual information is a number corresponding to the setting value at maximum. The reception-side user frame information operation processing unit 2029 acquires and aligns second individual information related to each user frame F2 in the order of the user frames F2 input to the reception FIFO queue 2011. The order of the user frames F2 input to the reception FIFO queue 2011 corresponds to the order in which the user frames F2 are read by the frame reading unit 2013. The reception-side user frame information operation processing unit 2029 generates reception-side operational information for each synchronization group.

The frame synchronization unit 2014 and the frame synchronization unit 2015 determines the order property of each frame via the plurality of relay paths (Step S54). In Step S54, the frame synchronization unit 2014 recognizes the order property of the synchronization frame F1 based on the synchronization frame identifier of the synchronization frame F1 via the first relay path, which has been read by the frame reading unit 2012, for example. The frame synchronization unit 2014 determines whether or not the order property of the synchronization frames F1 is accurate. The frame synchronization unit 2014 compares the transmission-side operational information acquired from the synchronization frame F1 with the reception-side operational information generated by the reception-side user frame information operation processing unit 2028 and recognizes the order property of the user frame F2 included in the synchronization group. In a case where each piece of first individual information included in the transmission-side operational information matches all pieces of the second individual information included in the reception-side operational information, the frame synchronization unit 2014 determines that the order of the user frames F2 included in the synchronization group identified with the value N of the synchronization frame identifier matches. The fact that the order of the user frames F2 matches corresponds to a fact that no frame loss has occurred in the user frame sequence included in the synchronization group and the order property of the user frame F2 is accurate. The fact that the order of the user frames F2 matches corresponds to a fact that the number of user frames F2 matches the setting value. In a case where a part of the first individual information included in the transmission-side operational information does not match the second individual information included in the reception-side operational information, the frame synchronization unit 2014 determines that the order of the user frames F2 included in the synchronization group identified with the value N of the synchronization frame identifier does not match. The fact that the order of the user frames F2 does not match corresponds to a fact that a frame loss has occurred in the user frame sequence included in the synchronization group and the order property of the user frames F2 is not accurate. The fact that the order of the user frames F2 does not match also corresponds to a fact that the number of user frames F2 does not match the setting value. In a case where the order of the user frames F2 does not match, the frame synchronization unit 2014 specifies the frame loss position in the user frame sequence included in the synchronization group through comparison between the transmission-side operational information and the reception-side operational information. The frame loss position is an alignment position of the user frame F2, in which the frame loss has occurred, in the user frame sequence in the synchronization group. In a case where the second individual information corresponding to the first individual information is not present in the reception-side operational information, for example, the frame synchronization unit 2014 specifies the frame loss of the user frame F2 corresponding to the first individual information. The frame synchronization unit 2014 specifies, as the frame loss position, the position of the user frame F2 where the frame loss has occurred based on the alignment order of the first individual information. The frame synchronization unit 2014 generates order information for each synchronization group identified with the value N of the synchronization frame identifier. The order information can include information indicating whether or not the order property of the synchronization frame F1 included in the synchronization group is accurate. The order information can include the value N of the synchronization frame identifier of the synchronization frame F1 included in the synchronization group. The order information can include information indicating that the order of the user frames F2 included in the synchronization group matches or does not match. In a case where the order information includes information indicating non-matching of the user frames F2, the order information can include information indicating the frame loss position.

The frame synchronization unit 2015 recognizes the order property of the synchronization frames F1 based on the synchronization frame identifiers of the synchronization frames F1 via the second relay path, which have been read by the frame reading unit 2013. The frame synchronization unit 2015 determines whether or not the order property of the synchronization frames F1 is correct. The frame synchronization unit 2015 compares the transmission-side operational information acquired from the synchronization frame F1 with the reception-side operational information generated by the reception-side user frame information operation processing unit 2029 and recognizes the order property of the user frames F2 included in the synchronization group. In a case where each piece of the first individual information included in the transmission-side operational information matches all pieces of the second individual information included in the reception-side operational information, the frame synchronization unit 2015 determines that the order of the user frames F2 included in the synchronization group identified with the value N of the synchronization frame identifier matches. In a case where a part of the first individual information included in the transmission-side operational information does not match the second individual information included in the reception-side operational information, the frame synchronization unit 2015 determines that the order of the user frames F2 included in the synchronization group identified with the value N of the synchronization frame identifier does not match. In a case where the order of the user frames F2 does not match, the frame synchronization unit 2015 specifies the frame loss position in the user frame sequence included in the synchronization group through comparison between the transmission-side operational information and the reception-side operational information. The frame synchronization unit 2015 generates order information for each synchronization group identified with the value N of the synchronization frame identifier. The order information can include information indicating whether or not the order property of the synchronization frame F1 included in the synchronization group is accurate. The order information can include the value N of the synchronization frame identifier of the synchronization frame F1 included in the synchronization group. The order information can include information indicating that the order of the user frames F2 included in the synchronization group matches or does not match. In a case where the order information includes information indicating non-matching of the user frames F2, the order information can include information indicating the frame loss position.

The user frame addition/deletion unit 2030 and the user frame addition/deletion unit 2031 delete the user frames F2 via the plurality of relay paths as needed and add dummy frames as needed (Step S55). In Step S55, in a case where the order information from the frame synchronization unit 2014 includes information indicating that the order property of the synchronization frame F1 is not accurate, for example, the user frame addition/deletion unit 2030 deletes the user frames F2 included until the next synchronization frame F1 with an accurate order property. In a case where the order information from the frame synchronization unit 2014 includes information indicating non-matching of the user frames F2, the user frame addition/deletion unit 2030 refers to the information indicating the frame loss position included in the order information and adds a dummy frame at the frame loss position in the user frame sequence in the synchronization group.

In a case where the order information from the frame synchronization unit 2015 includes information indicating that the order property of the synchronization frame F1 is not accurate, the user frame addition/deletion unit 2031 deletes the user frames F2 included until the next synchronization frame F1 with the accurate order property. In a case in which the order information from the frame synchronization unit 2015 includes information indicating non-matching of the user frames F2, the user frame addition/deletion unit 2031 refers to the information indicating the frame loss position included in the order information and adds a dummy frame at the frame loss position in the user frame sequence in the synchronization group.

The frame selection unit 2018 selects synchronization frames F1 and user frames F2 from the plurality of relay paths based on the order information from the frame synchronization unit 2014 and the order information from the frame synchronization unit 2015 (Step S56). In Step S56, the frame selection unit 2018 determines whether or not a frame loss has occurred in a user frame sequence in a synchronization group that has arrived earliest from among synchronization groups including the synchronization frames F1 identified with the same value of the synchronization frame identifier in each of the first relay path and the second relay path for each value N of the synchronization frame identifier based on the order information from the frame synchronization unit 2014 and the order information from the frame synchronization unit 2015. Here, in regard to the value N of a certain synchronization frame identifier, it is assumed that the synchronization group in the first relay path has arrived earlier than the synchronization group in the second relay path. For example, it is assumed that the order information from the frame synchronization unit 2014 includes information indicating that the order of the user frames F2 matches and the order property of the synchronization frame F1 is accurate. The frame selection unit 2018 determines that no frame loss has occurred in the user frame sequence in the synchronization group in the first relay path that has arrived earliest, based on the order information from the frame synchronization unit 2014. Because the order information from the frame synchronization unit 2014 is generated based at least on the transmission-side operational information, it is possible to state that the determination of the fact that no frame loss has occurred in the user frame sequence in the synchronization group in the first relay path that has arrived earliest is made based on the transmission-side operational information. On the other hand, it is assumed that the order information from the frame synchronization unit 2014 includes information indicating that the order of the user frames F2 does not match and information indicating that the order property of the synchronization frame F1 is accurate. The frame selection unit 2018 determines that a frame loss has occurred in the user frame sequence in the synchronization group in the first relay path that has arrived earliest, based on the order information from the frame synchronization unit 2014. Because the order information from the frame synchronization unit 2014 is generated based at least on the transmission-side operational information, it is possible to state that determination of the fact that a frame loss has occurred in the user frame sequence in the synchronization group in the first relay path that has arrived earliest is made based on the transmission-side operational information.

A case where it is determined that no frame loss has occurred in the user frame sequence in the synchronization group that has arrived earliest from among the synchronization groups identified with the same value of the synchronization frame identifier will be described. The frame selection unit 2018 selects the synchronization frame F1 and the user frame F2 constituting the synchronization group in the relay path that has arrived earliest. Because no frame loss in the user frame sequence has occurred in the synchronization group, the number of user frames F2 is a number corresponding to the setting value. On the other hand, the frame selection unit 2018 deletes a synchronization frame F1 and a user frame F2 constituting a synchronization group in a different relay path other than the relay path through which frames have arrived earliest out of the first relay path and the second relay path.

A case in which it is determined that a frame loss in a user frame has occurred in a synchronization group that has arrived earliest from among synchronization groups identified with the same value of the synchronization frame identifier will be described. The frame selection unit 2018 selects the synchronization frame F1 and the user frame F2 constituting the synchronization group in the relay path that has arrived earliest. Because the frame loss in the user frame sequence has occurred in the synchronization group, the number of user frames F2 is less than the number corresponding to the setting value. The frame selection unit 2018 refers to information indicating the frame loss position included in the order information and specifies the frame loss position in the user frame sequence. The frame selection unit 2018 selects the user frame F2 corresponding to the frame loss position from the synchronization group in the different relay path other than the relay path through which the frames have arrived earliest out of the first relay path and the second relay path.

The synchronization frame deletion unit 2019 deletes the synchronization frame F1 selected by the frame selection unit 2018 (Step S57). In Step S57, the synchronization frame deletion unit 2019 deletes the synchronization frame F1 out of the synchronization frame F1 and the user frame F2 selected by the frame selection unit 2018. On the other hand, the synchronization frame deletion unit 2019 outputs the user frame F2 out of the synchronization frame F1 and the user frame F2 selected by the frame selection unit 2018 to the transmission FIFO queue 2020. A frame sequence constituted by a plurality of user frames F2 is transmitted to the user terminal A1.

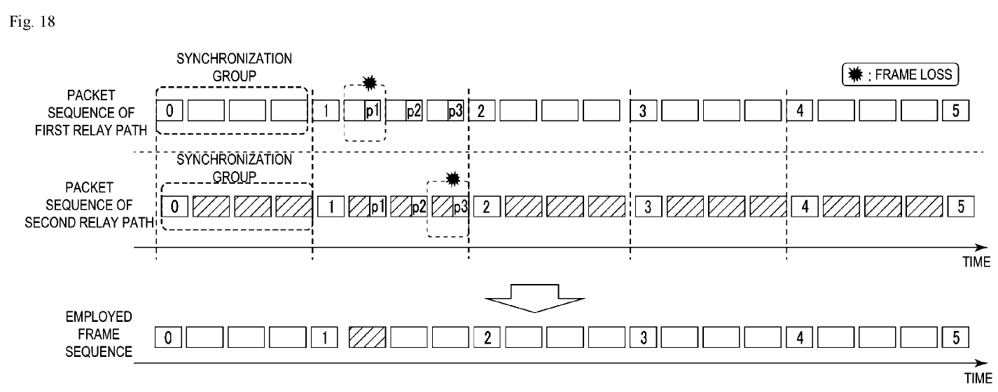

FIG. 18 is a diagram illustrating a frame sequence employed in reception processing performed by the uninterrupted apparatus A2.

The frame sequence via the first relay path is assumed to arrive at the uninterrupted apparatus A2 earlier than the frame sequence via the second relay path. The setting value n embedded in each synchronization frame F1 is assumed to be three. It is assumed that transmission-side operational information in which individual information p1 to p3 are aligned is embedded in each synchronization frame F1.

For the value zero of the synchronization frame identifier, for example, both the synchronization group in the first relay path and the synchronization group in the second relay path are synchronization groups with no frame loss in the user frame sequences. The synchronization group in the first relay path has arrived earlier than the synchronization group in the second relay path. The frame selection unit 2018 selects a synchronization frame F1 and user frames F2 of the number corresponding to the setting value, which constitute the synchronization group in the first relay path. On the other hand, the frame selection unit 2018 deletes the synchronization frame F1 and the user frames F2 constituting the synchronization group in the second relay path. The same applies to the values two, three, and four of the synchronization frame identifiers.

For the value one of the synchronization frame identifier, the synchronization group in the first relay path is a synchronization group in which a frame loss has occurred in the first frame in the user frame sequence. The synchronization group in the second relay path is a synchronization group in which a frame loss has occurred in the third frame in the user frame sequence. The synchronization group in the first relay path has arrived earlier than the synchronization group in the second relay path. The frame selection unit 2018 selects the synchronization frame F1 and the user frames F2 that are the second and third frames in the user frame sequence, which constitute the synchronization group in the first relay path. The frame selection unit 2018 selects the user frame F2 corresponding to the frame loss position (the first frame in the user frame sequence) in the synchronization group in the first relay path from the synchronization group in the second relay path. The frame selection unit 2018 deletes the dummy frame that is the first frame in the user frame sequence constituting the synchronization group in the first relay path. The frame selection unit 2018 deletes the synchronization frame F1, the user frame F2 as the second frame, and the dummy frame as the third frame in the user frame sequence, which constitute the synchronization group in the second relay path.

In this manner, the frame selection unit 2018 the synchronization frame F1 and the user frames F2 of the number corresponding to the setting value, which constitute the synchronization group in the first relay path for the values zero, two, three, and four of the synchronization frame identifiers. The frame selection unit 2018 selects the user frames F2 from the synchronization group in the first relay path and the synchronization group in the second relay path for the value one of the synchronization frame identifier.

### Actions and Effects

As described above, according to the third embodiment, the uninterrupted apparatus embeds the transmission-side operational information in the synchronization frame and transmits frame sequences constituted by a plurality of synchronization frames and a plurality of user frames via the plurality of relay paths. The uninterrupted apparatus specifies the frame loss position in the user frame sequence included in the synchronization group that has arrived earliest in the plurality of relay paths using the transmission-side operational information and selects the user frame F2 corresponding to the frame loss position from the synchronization group of the different relay path among the plurality of relay paths.

In this manner, it is possible to determine a loss frame, and even if there is a defective user frame in one relay path, it is possible to recover the defective user frame from the other relay path.

In short, the present invention is not limited to the aforementioned embodiments and can be variously modified in the implementation stage without departing from the gist of the present invention. Also, the embodiments may appropriately be performed in combination as long as possible, and in such a case, combined effects can be obtained. Further, the above embodiment includes the disclosures in various stages, and various disclosures can be extracted from appropriate combinations of a plurality of disclosed components.

REFERENCE SIGNS LIST

| | |
|---|---|
| 20 | Control unit |
| 21 | Storage unit |
| 22 | First communication I/F |
| 23 | Second communication I/F |
| 24 | Bus |
| 221 | Port |
| 231 | First port |
| 232 | Second port |
| 2001 | Reception FIFO queue |
| 2002 | Frame reading unit |
| 2003 | User frame number counter unit |
| 2004 | Synchronization frame generation unit |
| 2005 | Synchronization frame identifier application unit |
| 2006 | Synchronization frame insertion unit |
| 2007 | Frame copying unit |
| 2008 | Transmission FIFO queue |
| 2009 | Transmission FIFO queue |
| 2010 | Reception FIFO queue |
| 2011 | Reception FIFO queue |
| 2012 | Frame reading unit |
| 2013 | Frame reading unit |
| 2014 | Frame synchronization unit |
| 2015 | Frame synchronization unit |
| 2016 | User frame deletion unit |
| 2017 | User frame deletion unit |
| 2018 | Frame selection unit |
| 2019 | Synchronization frame deletion unit |
| 2020 | Transmission FIFO queue |
| 2021 | Synchronization frame insertion setting unit |
| 2022 | User frame number comparison unit |
| 2023 | User frame number comparison unit |
| 2024 | Synchronization frame insertion setting unit |
| 2025 | Transmission-side user frame information operation processing unit |
| 2026 | User frame number counter unit |
| 2027 | User frame number counter unit |
| 2028 | Reception-side user frame information operation processing unit |
| 2029 | Reception-side user frame information operation processing unit |
| 2030 | User frame addition/deletion unit |
| 2031 | User frame addition/deletion unit |
| A | Base |
| A1 | User terminal |
| A2 | Uninterrupted apparatus |
| B | Base |
| B1 | User terminal |
| B2 | Uninterrupted apparatus |
| C | Base |
| C1 | User terminal |
| F1 | Synchronization frame |
| F2 | User frame |
| S | Transmission/reception system |

1. A transmission apparatus comprising:
a processor; and
a storage medium having computer program instructions stored thereon, when executed by the processor, perform to:
generate a synchronization frame to be associated with one of user frames;
apply, to each synchronization frame
,a synchronization frame identifier that enables recognition of a transmission order property of the synchronization frame and embeds the synchronization frame identifier in the synchronization frame;
insert the synchronization frame with the synchronization frame identifier embedded therein into a point immediately after another user frame associated with another synchronization frame one before the user frame associated with the synchronization frame and immediately before the user frame associated with the synchronization frame; and
copy the user frame and the synchronization frame and outputs the copied frames to a plurality of transmission FIFO queues corresponding to a plurality of output ports.

2. (canceled)

3. (canceled)

4. (canceled)

5. (canceled)

6. (canceled)

7. A transmission method comprising:
generating a synchronization frame associated with a user frame;
applying a synchronization frame identifier that enables recognition of a transmission order property of the synchronization frame to each generated synchronization frame and embedding the synchronization frame identifier in the synchronization frame;
inserting the synchronization frame with the synchronization frame identifier embedded therein into a point immediately after another user frame associated with another synchronization frame one before the user frame associated with the synchronization frame and immediately before the user frame associated with the synchronization frame; and
copying the user frame and the inserted synchronization frame and outputting the copied frames to a plurality of transmission FIFO queues corresponding to a plurality of output ports.

8. A transmission/reception system comprising:
a transmission apparatus; and
a reception apparatus,
wherein the transmission apparatus includes
a synchronization frame generation unit configured to generate a synchronization frame associated with a user frame,
a synchronization frame identifier application unit configured to apply a synchronization frame identifier that enables recognition of a transmission order property of the synchronization frame to each synchronization frame generated by the synchronization frame generation unit and embeds the synchronization frame identifier in the synchronization frame,
a synchronization frame insertion unit configured to insert the synchronization frame with the synchronization frame identifier embedded therein by the synchronization frame identifier application unit into a point immediately after another user frame associated with another synchronization frame one before the user frame associated with the synchronization frame and immediately after the user frame associated with the synchronization frame, and
a frame copying unit configured to copy the user frame and the synchronization frame inserted by the synchronization frame insertion unit and output the copied frames to a plurality of transmission FIFO queues corresponding to a plurality of output ports, and
the reception apparatus includes
a frame reading unit configured to read the user frame and the synchronization frame with the synchronization frame identifier embedded therein, the synchronization frame identifier being input in order from a plurality of paths to a plurality of reception FIFO queues,
a frame selection unit configured to employ a synchronization group constituted by one of the synchronization frames read by the frame reading unit in a path through which the synchronization frames arrive in a correct order determined based on the synchronization frame identifiers and arrive earliest from among the plurality of paths and one of the user frames associated with the synchronization frame, and
a synchronization frame deletion unit configured to delete the synchronization frame out of the synchronization frame and the user frames included in the synchronization group employed by the frame selection unit and output the user frames included in the synchronization group employed by the frame selection unit to a transmission FIFO queue.
